(19) United States
(12) Patent Application Publication
(10) Pub. No.: US 2025/0174079 A1
(43) Pub. Date: May 29, 2025

(54) REAL-WORLD EVENT AUGMENTED GAMES SYSTEM

(71) Applicant: Augmented Sports Inc., Chicago, IL (US)

(72) Inventor: Haibo Lu, Chicago, IL (US)

(21) Appl. No.: 18/959,556

(22) Filed: Nov. 25, 2024

Related U.S. Application Data
(60) Provisional application No. 63/554,699, filed on Feb. 16, 2024.
(60) Provisional application No. 63/603,571, filed on Nov. 28, 2023.

(51) Int. Cl. G07F 17/32; G06Q 50/34

(52) U.S. Cl. CPC G07F 17/323; G06Q 50/34; G07F 17/3288

(57) ABSTRACT

Included in the present disclosure is a system for determining a user score, including a processor and a memory storing instructions that, when executed by the processor, cause the system to generate an entry for a user, retrieve real-time data associated with the one or more attributes for the one or more entities, and determine and update the user score in real-time. In some embodiments, determining and updating the user score is based on computing an attribute score for each of the attributes using statistical data and a weighted distribution thereby forming a computed attribute score, applying the modifiers to modify the computed attribute score for at least one of the one or more attributes to generate one or more modified attribute scores, and aggregating the one or more modified attribute scores and any unmodified attribute scores to generate the user score.

### CROSS-REFERENCE TO RELATED APPLICATIONS

The present application claims priority to U.S. Provisional Patent Application No. 63/603,571; filed on Nov. 28, 2023; and entitled AUGMENTED FANTASY SPORTS SYSTEM, and which is incorporated herein by reference in its entirety.

The present application claims priority to U.S. Provisional Patent Application No. 63/554,699; filed on Feb. 16, 2024; and entitled REAL-WORLD EVENT AUGMENTED GAMES SYSTEM, and which is incorporated herein by reference in its entirety.

### TECHNICAL FIELD

The present disclosure is related to the field of fantasy sports. Specifically, the present disclosure is related to the field of modifying fantasy sports.

### BACKGROUND OF THE INVENTION

Fantasy sports, including its most popular variant, football, emerged in the 1960s as an informal pastime among groups of friends and sports enthusiasts. Initially, participants manually tracked player statistics from real-life football games, calculating points based on various performance metrics.

The concept gained traction with the advent of the Internet in the 1990s, enabling the development of online platforms that streamlined the process and expanded the player base. As technology advanced, fantasy football transformed into a widespread and immersive experience, incorporating features like live scoring, player drafts, and interactive interfaces, further enhancing its appeal and accessibility.

Over time, the popularity of fantasy football spurred the creation of similar fantasy sports leagues across various disciplines, including basketball, baseball, and soccer. These games share the fundamental concept of participants assembling virtual teams of real athletes and competing based on their on-field performances. The evolution of fantasy sports mirrors the intersection of technology, sports fandom, and communal engagement, transforming a casual hobby into a global phenomenon that has become an integral part of modern sports culture.

Trading card games (TCGs) originated in the early 1990s as a novel fusion of collectible cards and strategic gameplay. Players construct personalized decks from a pool of unique cards, each featuring various characters, creatures, spells, or other game elements. The objective is to employ strategic thinking, resource management, and tactical decision-making to outmaneuver opponents in head-to-head battles. TCGs typically involve a mix of chance and skill, with players engaging in matches where the outcome depends on card draws, deck-building strategies, and the execution of game mechanics. As the genre gained popularity, it spawned a diverse array of themes and settings, attracting enthusiasts of all ages and creating a vibrant community centered around trading, deck customization, and competitive play. The success of TCGs also paved the way for digital adaptations, enabling players to enjoy the experience online, further broadening the reach and accessibility of these engaging and dynamic card games.

### SUMMARY OF THE INVENTION

Included in the present disclosure is a system for determining a user score, the system including one or more processors. In some embodiments, the system includes one or more memories storing instructions that, when executed by the one or more processors, cause the system to perform operations. According to some embodiments, these operations include generating an entry for a user. The entry may include one or more entities, each entity associated with one or more attributes that are each correlated with a corresponding attribute score. In some embodiments, the entry includes one or more modifiers configured to modify a respective attribute score for at least one of the one or more attributes. According to some embodiments, the operations include retrieving real-time data associated with the one or more attributes for the one or more entities. The real-time data may include statistical data relating to at least some of the one or more attributes. In some embodiments, the real-time data includes one or more factors relating to at least some of the one or more modifiers. According to some embodiments, the operations include determining and updating the user score in real-time. Determining and updating the user score in real-time may be based on computing the attribute score for each of the one or more attributes using the statistical data and a weighted distribution thereby forming a computed attribute score. In some embodiments, determining and updating the user score in real-time is based on applying the one or more modifiers to modify the computed attribute score for the at least one of the one or more attributes to generate one or more modified attribute scores, wherein a modification by the at least some of the one or more modifiers is based on the one or more factors. According to some embodiments, determining and updating the user score in real-time is based on aggregating the one or more modified attribute scores and any unmodified attribute scores to generate the user score.

The entry may be generated based on a user selection of the one or more entities, one or more modifiers, or both. In some embodiments, at least part of the entry is generated automatically based on a prediction by the one or more processors for maximizing the user score.

According to some embodiments, each of the one or more entities is associated with an entity value, and wherein the entry is limited to a maximum entity value, such that a sum of entity values of the one or more entities does not exceed the maximum entity value. Each entity value for a given entity may be variable and based on i) a concentration of the given entity being used in a current entry, a previous entry, or both, for the user or one or more other participants, ii) past statistical data temporally prior to the current entry, or iii) both. In some embodiments, the one or more processors adjusts the entity value based on a threshold of concentration being detected. According to some embodiments, an adjustment of the entity value is performed automatically.

Each of the one or more modifiers may be associated with a modifier value, and wherein the entry is limited to a maximum modifier value, such that a sum of modifier values of the one or more modifiers does not exceed the maximum modifier value. In some embodiments, each modifier value for a given modifier is variable and based on i) a concentration of the given modifier being used in a current entry, a previous entry, or both, for the user or one or more other participants, ii) historical and/or predictive data relating to the one or more factors, or iii) both. According to some embodiments, the one or more processors adjusts the modifier value based on a threshold of concentration being detected.

The one or more attributes may include a statistical record relating to an action by an entity of the one or more entities. In some embodiments, the entity corresponds to a sports player. According to some embodiments, the entity corresponds to a professional football player as part of a national football league.

The one or more attributes may be selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

In some embodiments, a plurality of modifiers of the one or more modifiers is configured to modify a single attribute score, such that the modification by the plurality of modifiers is compounded. According to some embodiments, at least some of the one or more factors include the retrieved statistical data.

At least some of the one or more factors may be external factors independent of statistical data retrieved. In some embodiments, the external factors are selected from the group consisting of weather, a stadium attendance, entity inactivity, entity injury, home field advantage, away games, and combinations thereof.

According to some embodiments, the operations further include ranking the user score for a plurality of users according to value, wherein the ranking is continually updated based on the real-time data retrieved for each user. The weighted distribution may be based on an algorithm applying pre-determined weights to each attribute score associated with the entry.

Also included in the present disclosure is a system for determining a user score, including a processor. In some embodiments, the system includes a memory storing instructions that, when executed by the processor, cause the system to perform operations. According to some embodiments, the operations include generating an entry for a user. The entry may include an entity, the entity associated with an attribute that is correlated with an attribute score. In some embodiments, the entry includes a modifier configured to modify the attribute score for the attribute. According to some embodiments, the operations include retrieving real-time data associated with the attribute for the entity, the real-time data including statistical data relating to the attribute. The operations may include determining and updating the user score in real-time. In some embodiments, determining and updating the user score in real-time is based on computing the attribute score for the attribute using the statistical data and a weighted distribution thereby forming a computed attribute score. According to some embodiments, determining and updating the user score in real-time is based on applying the modifier to modify the computed attribute score for the attribute to generate a modified attribute score. Determining and updating the user score in real-time may be based on aggregating the modified attribute score and an additional unmodified attribute score associated with the entry to generate the user score.

In some embodiments, retrieving real-time data is associated with the attribute for the entity, and the real-time data further includes a factor relating to the modifier. According to some embodiments, a modification by the modifier is based on the factor. The factor may include the retrieved statistical data. In some embodiments, the factor is an external factor independent of statistical data retrieved. According to some embodiments, the external factor is selected from the group consisting of weather, a stadium attendance, entity inactivity, entity injury, home field advantage, away games, and combinations thereof.

The entry may be generated based on a user selection of the entity, the modifier, or both. In some embodiments, at least part of the entry is generated automatically based on a prediction by the processor for maximizing the user score.

According to some embodiments, the entity is associated with an entity value. The entry may be limited to a maximum entity value, such that a sum of entity values of a plurality of entity values associated with the entry does not exceed the maximum entity value. In some embodiments, the entity value for the entity is variable and based on i) a concentration of the entity being used in a current entry, a previous entry, or both, for the user or another participant, ii) past statistical data temporally prior to the current entry, or iii) both. According to some embodiments, the processor adjusts the entity value based on a threshold of concentration being detected. An adjustment of the entity value may be performed automatically.

In some embodiments, the modifier is associated with a modifier value. According to some embodiments, the entry is limited to a maximum modifier value, such that a sum of modifier values of a plurality of modifiers associated with the entry does not exceed the maximum modifier value. Each modifier value for a modifier may be variable and based on i) a concentration of the modifier being used in a current entry, a previous entry, or both, for the user or another participant, ii) historical and/or predictive data relating to the one or more factors, or iii) both. In some embodiments, the processor adjusts the modifier value based on a threshold of concentration being detected.

According to some embodiments, the attribute includes a statistical record relating to an action by the entity. The entity may correspond to a sports player. In some embodiments, the entity corresponds to a professional football player as part of a national football league.

According to some embodiments, the attribute is selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

The modifier may be one of a plurality of modifiers configured to modify a single attribute score, such that a modification by the plurality of modifiers is compounded. In some embodiments, the user is one of a plurality of users. According to some embodiments, the operations further include ranking the user score for the plurality of users according to value. The ranking may be continually updated based on the retrieved real-time data for each user.

In some embodiments, the weighted distribution is based on an algorithm applying pre-determined weights to each attribute score of a plurality of attribute scores associated with the entry.

Also included in the present disclosure is a non-transitory, computer-readable media, executable by a processor, and configured to cause the processor to perform the step of generating an entry for a user. In some embodiments, the entry includes one or more entities, each entity associated with one or more attributes that are each correlated with a corresponding attribute score. According to some embodiments, the entry includes one or more modifiers configured to modify a respective attribute score for at least one of the one or more attributes. The non-transitory, computer-readable media may be configured to cause the processor to perform the step of retrieving real-time data associated with the one or more attributes for the one or more entities. In some embodiments, the real-time data includes statistical data relating to at least some of the one or more attributes. According to some embodiments, the real-time data includes one or more factors relating to at least some of the one or more modifiers. The non-transitory computer-readable media may be configured to cause the processor to perform the step of determining and updating the user score in real-time. In some embodiments, determining and updating the user score in real-time is based on computing the attribute score for each of the one or more attributes using the statistical data and a weighted distribution thereby forming a computed attribute score. According to some embodiments, determining and updating the user score in real-time is based on applying the one or more modifiers to modify the computed attribute score for the at least one of the one or more attributes to generate one or more modified attribute scores. A modification by the at least some of the one or more modifiers may be based on the one or more factors. Determining and updating the user score in real-time may be based on aggregating the one or more modified attribute scores and any unmodified attribute scores to generate the user score.

In some embodiments, the entry is generated based on a user selection of the one or more entities, one or more modifiers, or both. According to some embodiments, at least part of the entry is generated automatically based on a prediction by the one or more processors for maximizing the user score.

Each of the one or more entities may be associated with an entity value. In some embodiments, the entry is limited to a maximum entity value, such that a sum of entity values of the one or more entities does not exceed the maximum entity value.

According to some embodiments, each entity value for a given entity is variable and based on i) a concentration of the given entity being used in a current entry, a previous entry, or both, for the user or one or more other participants, ii) past statistical data temporally prior to the current entry, or iii) both. The non-transitory computer-readable media may be configured to further cause the processor to perform the step of adjusting the entity value based on a threshold of concentration being detected. In some embodiments, an adjustment of the entity value is performed automatically.

According to some embodiments, each of the one or more modifiers is associated with a modifier value. The entry may be limited to a maximum modifier value, such that a sum of modifier values of the one or more modifiers does not exceed the maximum modifier value.

In some embodiments, each modifier value for a given modifier is variable and based on i) a concentration of the given modifier being used in a current entry, a previous entry, or both, for the user or one or more other participants, ii) historical and/or predictive data relating to the one or more factors, or iii) both. According to some embodiments, the non-transitory, computer-readable media is configured to further cause the processor to perform the step of adjusting the modifier value based on a threshold of concentration being detected.

The one or more attributes may include a statistical record relating to an action by an entity of the one or more entities. In some embodiments, the entity corresponds to a sports player. According to some embodiments, the entity corresponds to a professional football player as part of a national football league.

The one or more attributes may be selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

In some embodiments, a plurality of modifiers of the one or more modifiers is configured to modify a single attribute score, such that the modification by the plurality of modifiers is compounded. According to some embodiments, at least some of the one or more factors include the retrieved statistical data. At least some of the one or more factors may be external factors independent of statistical data retrieved.

In some embodiments, the external factors are selected from the group consisting of weather, a stadium attendance, entity inactivity, entity injury, home field advantage, away games, and combinations thereof. According to some embodiments, the non-transitory, computer-readable media is configured to further cause the processor to perform the step of ranking the user score for a plurality of users according to value. The ranking may be continually updated based on the real-time data retrieved for each user. In some embodiments, the weighted distribution is based on an algorithm applying pre-determined weights to each attribute score associated with the entry.

Also included in the present disclosure is a non-transitory, computer-readable media, executable by a processor, and configured to cause the processor to perform the step of generating an entry for a user. In some embodiments, the entry includes an entity, the entity associated with an attribute that is correlated with an attribute score. According to some embodiments, the entry includes a modifier configured to modify the attribute score for the attribute. The non-transitory, computer-readable media may be configured to cause the processor to perform the step of retrieving real-time data associated with the attribute for the entity, the real-time data including statistical data relating to the attribute. In some embodiments, the non-transitory, computer-readable media is configured to cause the processor to perform the step of determining and updating the user score in real-time. According to some embodiments, determining and updating the user score in real-time is based on computing the attribute score for the attribute using the statistical data and a weighted distribution thereby forming a computed attribute score. In some embodiments, determining and updating the user score in real-time is based on applying the modifier to modify the computed attribute score for the attribute to generate a modified attribute score. Determining and updating the user score in real-time may be based on aggregating the modified attribute score and an additional unmodified attribute score associated with the entry to generate the user score.

In some embodiments, retrieving real-time data is associated with the attribute for the entity, and the real-time data further includes a factor relating to the modifier. According to some embodiments, a modification by the modifier is based on the factor. The factor may include the retrieved statistical data. In some embodiments, the factor is an external factor independent of statistical data retrieved.

According to some embodiments, the external factor is selected from the group consisting of weather, a stadium attendance, entity inactivity, entity injury, home field advantage, away games, and combinations thereof. The entry may be generated based on a user selection of the entity, the modifier, or both. In some embodiments, at least part of the entry is generated automatically based on a prediction by the processor for maximizing the user score.

According to some embodiments, the entity is associated with an entity value. The entry may be limited to a maximum entity value, such that a sum of entity values of a plurality of entity values associated with the entry does not exceed the maximum entity value.

In some embodiments, the entity value for the entity is variable and based on i) a concentration of the entity being used in a current entry, a previous entry, or both, for the user or another participant, ii) past statistical data temporally prior to the current entry, or iii) both. According to some embodiments, the non-transitory, computer-readable media is configured to further cause the processor to perform the step of adjusting the entity value based on a threshold of concentration being detected. An adjustment of the entity value may be performed automatically.

In some embodiments, the modifier is associated with a modifier value. According to some embodiments, the entry is limited to a maximum modifier value, such that a sum of modifier values of a plurality of modifiers associated with the entry does not exceed the maximum modifier value.

Each modifier value for a modifier may be variable and based on i) a concentration of the modifier being used in a current entry, a previous entry, or both, for the user or another participant, ii) historical and/or predictive data relating to the one or more factors, or iii) both. In some embodiments, the non-transitory, computer-readable media is configured to further cause the processor to perform the step of adjusting the modifier value based on a threshold of concentration being detected.

According to some embodiments, the attribute includes a statistical record relating to an action by the entity. The entity may correspond to a sports player. In some embodiments, the entity corresponds to a professional football player as part of a national football league.

According to some embodiments, the attribute is selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

The modifier may be one of a plurality of modifiers configured to modify a single attribute score, such that a modification by the plurality of modifiers is compounded. In some embodiments, the user is one of a plurality of users. According to some embodiments, the non-transitory, computer-readable media is further configured to cause the processor to perform the step of ranking the user score for the plurality of users according to value. The ranking may be continually updated based on the retrieved real-time data for each user. The weighted distribution may be based on an algorithm applying pre-determined weights to each attribute score of a plurality of attribute scores associated with the entry.

Also included in the present disclosure is a method, including generating an entry for a user. In some embodiments, the entry includes an entity associated with an attribute, the attribute correlated with an attribute score. According to some embodiments, the entry includes a modifier configured to modify the attribute score. The method may include retrieving real-time data associated with the attribute, the real-time data including statistical data relating to the attribute. In some embodiments, the method includes modifying the attribute score based on the modifier. According to some embodiments, the method includes determining a user score based at least partly on a weighted distribution of a plurality of modified attribute scores. The method may include updating the user score in real-time based on the real-time data.

In some embodiments, updating the user score includes computing the attribute score for the attribute using the statistical data and the weighted distribution. According to some embodiments, updating the user score further includes aggregating the modified attribute score and any unmodified attribute scores to generate the user score.

The real-time data may further include a factor relating to the modifier. In some embodiments, updating the user score includes computing the attribute score for the attribute using the statistical data and the weighted distribution. According to some embodiments, modifying the attribute score further includes applying the modifier to modify the computed attribute score for the attribute to generate a modified attribute score. A modification by the modifier may be based on the factor. Updating the user score may further include aggregating the modified attribute score and any unmodified attribute scores to generate the user score.

In some embodiments, generating the entry for the user includes the user selecting the entity, the modifier, or both. According to some embodiments, generating the entry for the user includes automatically generating the entry based on a prediction by a processor for maximizing the user score. The method may further include associating the entity with an entity value.

In some embodiments, the method further includes limiting the entry to a maximum entity value, such that a sum of entity values of multiple selected entities associated with the entry does not exceed the maximum entity value. According to some embodiments, the method further includes varying the entity value for the entity based on a concentration of the entity being used in a current entry, a previous entry, or both, for the user or another participant. The method may further include varying the entity value for the entity based on past statistical data. In some embodiments, the method further includes varying the entity value for the entity based on a concentration of the entity being used in a current entry, a previous entry, or both, for the user or another participant and past statistical data.

According to some embodiments, the method further includes adjusting the entity value based on a threshold of concentration being detected. The method may further include automatically performing the adjustment of the entity value.

In some embodiments, the method further includes associating the modifier with a modifier value. According to some embodiments, the method further includes limiting the entry to a maximum modifier value, such that a sum of modifier values of multiple selected modifiers associated with the entry does not exceed the maximum modifier value. The method may further include varying the modifier value for the modifier based on a concentration of the modifier being used in a current entry, a previous entry, or both, for the user or another participant. In some embodiments, the method further includes adjusting the modifier value based on a threshold of concentration being detected. According to some embodiments, the method further includes automatically performing the adjustment of the modifier value.

The method may further include associating the modifier with a modifier value. In some embodiments, the method further includes limiting the entry to a maximum modifier value, such that a sum of modifier values of multiple selected modifiers associated with the entry does not exceed the maximum modifier value. According to some embodiments, the method further includes varying the modifier value for a given modifier based on historical and/or predictive data relating to the factor. The method may further include varying the modifier value for a given modifier based on a concentration of the given modifier being used in a current entry, a previous entry, or both, for the user or another participant and historical and/or predictive data relating to the factor.

In some embodiments, the method further includes adjusting the modifier value based on a threshold of concentration being detected. According to some embodiments, the method further includes automatically performing the adjustment of the modifier value. The modifier may be one of a plurality of modifiers. In some embodiments, the method further includes modifying a single attribute score, such that a modification by the plurality of modifiers is compounded.

According to some embodiments, the method further includes including the retrieved statistical data in the factor. The method may further include ranking the user score for a plurality of users according to value. In some embodiments, the method further includes continually updating the ranking based on the retrieved real-time data for each user of the plurality of users. According to some embodiments, the method further includes applying a pre-determined weight to each attribute score of a plurality of attribute scores associated with the entry.

Also included in the present disclosure is a method, including generating an entry for a user. In some embodiments, the entry includes one or more entities, each entity associated with one or more attributes that are each correlated with a corresponding attribute score. According to some embodiments, the entry includes one or more modifiers configured to modify a respective attribute score for at least one of the one or more attributes. The method may include retrieving real-time data associated with the one or more attributes for the one or more entities. In some embodiments, the real-time data includes statistical data relating to at least some of the one or more attributes. According to some embodiments, the real-time data includes one or more factors relating to at least some of the one or more modifiers. The method may include determining the user score in real-time. In some embodiments, determining the user score in real-time is based on computing the attribute score for each of the one or more attributes using the statistical data and a weighted distribution thereby forming a computed attribute score. According to some embodiments, determining the user score in real-time is based on applying the one or more modifiers to modify the computed attribute score for the at least one of the one or more attributes to generate one or more modified attribute scores, wherein a modification by the at least some of the one or more modifiers is based on the one or more factors. Determining the user score in real-time may be based on aggregating the one or more modified attribute scores and any unmodified attribute scores to generate the user score.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1A illustrates a block diagram of a system including a processor and memory, according to some embodiments.

FIG. 1B illustrates a block diagram of a non-transitory computer-readable media, according to some embodiments.

FIG. 2 illustrates a block diagram including an entry, real-time data, a user score, and a weighted distribution, according to some embodiments.

FIG. 3 illustrates a block diagram of an entry, according to some embodiments.

FIG. 4 illustrates a block diagram of an entity value, according to some embodiments.

FIG. 5 illustrates an additional block diagram of an entry, according to some embodiments.

FIG. 6 illustrates a block diagram of a modifier value, according to some embodiments.

FIG. 7 illustrates a block diagram of an attribute, according to some embodiments.

FIG. 8 illustrates a block diagram of a modifier, according to some embodiments.

FIG. 9 illustrates a block diagram of an external factor, according to some embodiments.

FIG. 10 illustrates a flow chart depicting a method of generating a user score, according to some embodiments.

FIG. 11 illustrates a flow chart depicting a method of computing a score, according to some embodiments.

FIG. 12 illustrates a flow chart depicting a method of ascertaining an entity value, according to some embodiments.

FIG. 13 illustrates a flow chart depicting a method of ascertaining a modifier value, according to some embodiments.

FIG. 14 illustrates a flow chart depicting a method of modifying a score, according to some embodiments.

FIG. 15 illustrates a diagram of a graphical user interface (GUI) including entities prior to selection, according to some embodiments.

FIG. 16 illustrates a diagram of a GUI including entities after selection, according to some embodiments.

FIG. 17 illustrates a diagram of a GUI including modifiers prior to selection, according to some embodiments.

FIG. 18 illustrates a diagram of a GUI including modifiers after selection, according to some embodiments.

### DETAILED DESCRIPTION OF THE INVENTION

The present disclosure includes the use of real-world events to generate randomness for effects (such as trading card-based effect games (TCGs)). This can be performed through an electronic interface, such as a computing device.

Many TCGs generate randomness through interacting with a physical implement, i.e., shuffling cards, flipping coins, and/or rolling dice. The present disclosure includes the generation of randomness through non-physical interactions, such as statistics taken from real-world events. Stated another way, real-life randomness is used to generate randomness within the games.

In some embodiments, this may be accomplished through an electronic interface where a live data feed from a real-life event is sent to a server. The data is then processed through computational algorithms that transform the data, such as via transformations specified through various card mechanics. This now-transformed data is then provided to the user through a client-side user interface (UI), which may be accessible through an application running on a computing device (e.g., a web browser or a mobile application).

Users may then use this transformed data to play various games in either a player-versus-player (PVP) or tournament-style setting. Implementations of the present disclosure are detailed further below.

As used throughout the present disclosure, a “user” refers to any person(s) who are participating in the game(s) described herein.

As used throughout the present disclosure, a “player” refers to any entity not participating in the game(s) but the actions of which and/or who affect the gameplay.

As used throughout the present disclosure, “points” are a numerical product which constitute a “score,” and may refer to an unmodified score, a computed score, a weighted score, a modified score, or any combinations thereof.

In some embodiments, a game interacts with the real world. According to some embodiments, the game is a video game, although the game may take any form of game. The game may be a card game and/or may be played on a computing device. In some embodiments, the game combines a real-world or real-world-derived number with a modifier and/or attribute. According to some embodiments, this real-world number and/or real-world-derived number acts as and/or is a stand-in for a random number generated (RNG) number. For example, the real-world or real-world-derived number may be statistics and/or a fantasy football score for a player, which may correspond to a given sporting event (e.g., football game). The game, as described herein, might include changing the score (e.g., a fantasy football score, or overall score for the user) based on the modifier and/or attribute (such as a buff and/or debuff card) it is combined with. The game could be used for any sport, including for example, basketball, hockey, baseball, soccer, tennis, cricket, etc. It should be understood, however, that the game could be entirely unrelated to sports, although the concept of the game, including elements from fantasy football, will be used for ease of discussion and clarification. In some embodiments, the game is played on a computing device because it may only be properly implemented on a computing device.

The real-world events that the game interacts with and/or takes information from may be events the user has no control over. For example, the game may be based on football scores (e.g., statistics) of a professional football player, and the user may be someone entirely unrelated to the professional football player, or the professional football player themselves. In this embodiment, the professional football player may have variable statistics in the game, which may be based on how they perform in real life (e.g., how they perform in a given football game).

The variability in the game may be driven technically by the retrieval of data, such as a fantasy football score, from one or more outside sources. In some embodiments, the outside sources are third-party information systems, which may be run on or originate from independent computing systems and/or networks. This may be one reason why the game might only be implemented in a computing system.

The scoring of the game may be determined in many different ways, such as incorporating the modifiers and/or attributes, which may take the form of a card(s), affecting the score determined based on the real-world event. The scoring of the game may alternatively be determined by modifying the score of the card(s) using data from the real-world event. It should be understood, however, that these are some but not all examples of how the game may work and that the combination of a real-world event and a game, such as a card game, may take many different forms.

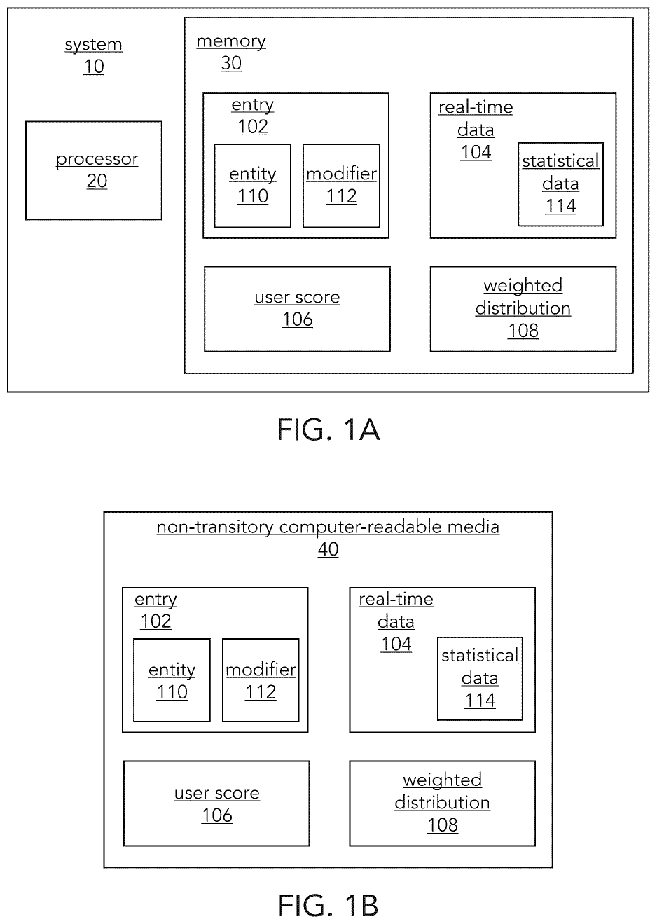

FIG. 1A illustrates an exemplary block diagram of a system 10 including a processor 20 and memory 30. As seen in FIG. 1A, the memory 30 stores information pertaining to an entry 102, real-time data 104, a user score 106, and a weighted distribution 108. In FIG. 1A, the memory 30 may be any of a hard drive (or solid-state drive), a flash memory, cloud storage, or other, similar forms of computational memory.

FIG. 1B illustrates an exemplary block diagram of a non-transitory computer-readable media 40. In FIG. 1B, the non-transitory computer-readable media 40 includes information pertaining to the entry 102, real-time data 104, the user score 106, and the weighted distribution 108. Because this data is stored on a non-transitory computer-readable media 40 in FIG. 1B, this information may be freely transferred by a user between processors of different systems, allowing for transportation of the data outside of a permanently placed or cloud memory.

In each of FIGS. 1A and 1B, the entry 102 includes an entity 110 and a modifier 112. As used herein, an entity 110 is anything occurring in the physical world that may generate some type of statistic and/or a collection of statistics. The examples used herein pertain to football, and in these examples, the entities 110 may include the players and/or coaches of a football game (or games). In other examples, other real-world events may generate the entities. These alternate examples may include other sports, such as hockey, baseball, soccer (fútbol), cricket, horse racing, basketball, fencing, bowling, judo, surfing, badminton, archery, softball, rugby, table tennis (ping pong), boxing, volleyball, squash, shooting (i.e., skeet shooting or target shooting), handball, pickleball, etc. In still additional examples, other real-world events that include statistics may be used, such as debates, general politics, weather, traffic patterns, the stock market, etc.

Also seen in each of FIGS. 1A and 1B is the real-time data 104 including statistical data 114. This statistical data 114 may be associated with the event that the entities 110 are a part of and/or statistics driven by the entities 110 themselves.

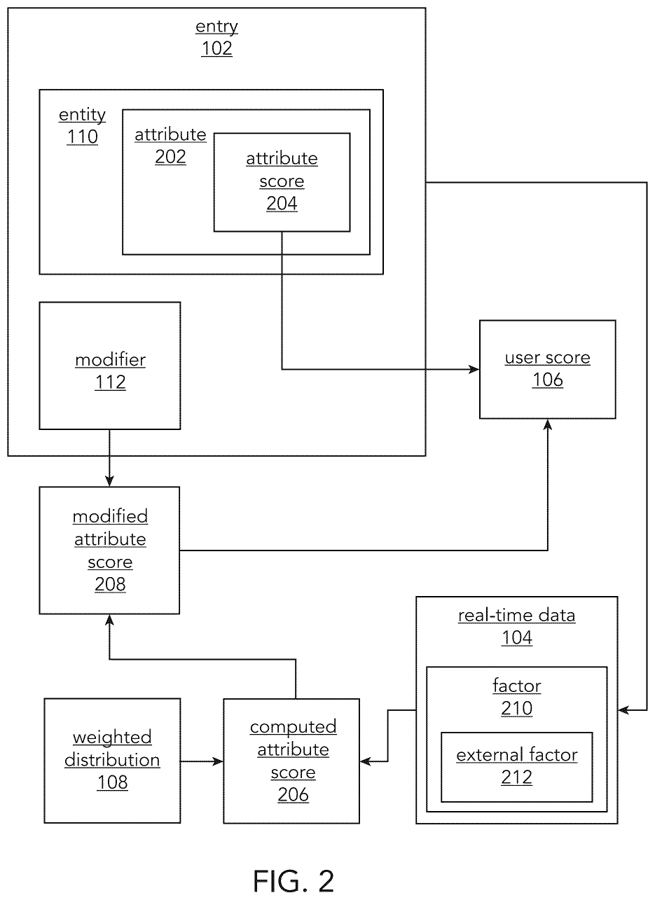

The interconnection between the entry 102, the real-time data 104, the user score 106, and the weighted distribution 108 is explored in greater detail in FIG. 2 below. Additionally, further detail regarding ways in which the modifier 112 may operate is discussed further in FIG. 9 below.

FIG. 2 illustrates an exemplary block diagram including an entry 102, real-time data 104, a user score 106, and a weighted distribution 108. As seen in FIG. 2 and discussed above, the entry 102 includes an entity 110 and a modifier 112. As will be detailed below, multiple entities 110 and modifiers 112 may be included in the entry 102. In many embodiments, the entity 110 is selected by the user, and thus included as a part of their entry 102.

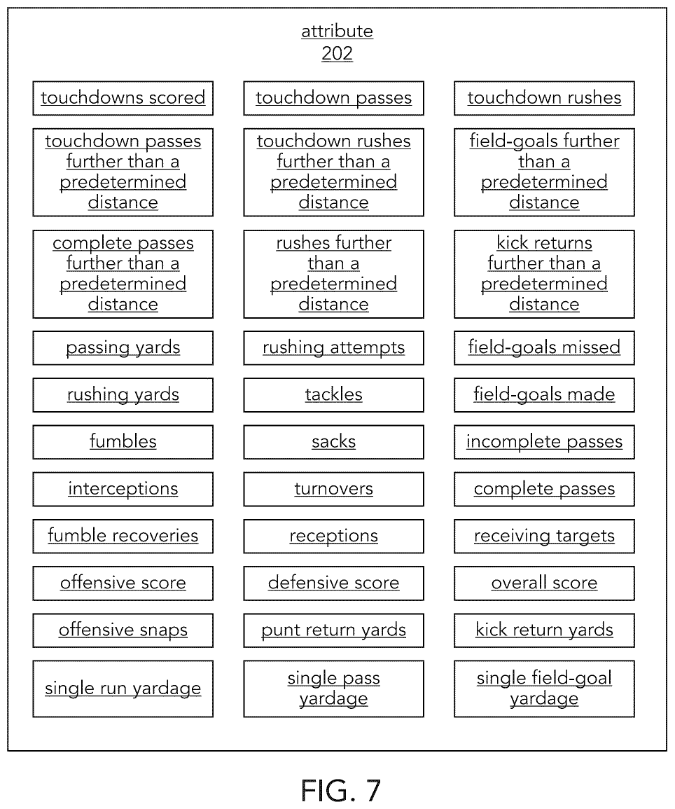

The entity 110 may further include an attribute 202. Using the example of football, this attribute 202 may be rushing yards for a running back. Actions taken by the entity 110 with respect to this attribute 202 then drive an attribute score 204, giving a raw numerical value. Continuing with the example of rushing yards for a running back—if a selected running back (entity 110) rushes for 76 yards during an event (i.e., football game), the attribute score 204 would be 76 (rushing yards). This raw numerical data is considered to be an “unweighted” or “unmodified” attribute score, but for the sake of clarity, this data will be called the attribute score 204 throughout the present specification. FIG. 7 explores a number of possible attributes 202 being monitored, using football as the example.

The attribute score 204 imparts information on top of the real-time data 104. In addition to the data derived from the attribute score 204, other factors 210 are included in the real-time data 104. These factors 210 may include external factors 212. External factors 212 are discussed in further detail in FIG. 9 below.

Also seen in FIG. 2 is a weighted distribution 108. This weighted distribution 108 may be an additional type of modifier that is used to fairly distribute points for each attribute score 204. For example, if one attribute 202 being tracked is touchdowns, and another attribute 202 being tracked is rushing yards, it would be uneven to use the raw numerical data driven by the respective attribute scores 204 for these attributes 202. One would expect to see a greater number of yards rushed than total touchdowns. The weighted distribution 108 takes this inequality between different attributes 202 and modifies them so that they are, at least partially, on par with each other present attribute 202 being tracked. The weighted distribution 108 interacts with the real-time data 104 in order to generate a computed attribute score 206.

Also included in the entry 102 is a modifier 112. The modifier 112 is an additional system for further modifying the attribute score 204. Specifically, the modifier 112 is used with the computed attribute score 206 in order to generate a modified attribute score 208. In many embodiments, the modifier 112 is selected by the user, and thus included in their entry 102. A list of some example modifiers 112 is presented at the end of this section.

In some embodiments, the attribute score 204 (i.e., unweighted or unmodified attribute score) along with the modified attribute score 208 then drive the user score 106. That is to say, some of the raw data obtained from the attribute 202, i.e., the attribute score 204, is used along with some of the numerical values driven by each of the real-time data 104, weighted distribution 108, and any chosen modifiers 112, which create the modified attribute score 208.

A non-exhaustive list of modifiers 112 as may be applied to a football game follow. Numerical values for points or statistics are by way of example only.

### Exemplary Modifiers

The user's defense (e.g., an entity) gets a 2.5 times multiplier to their score (e.g., computed attribute score).

The user's kicker gets a 2.5 times multiplier to their score.

The user's quarterback gets a 2 times multiplier to their score.

The user's running back gets a 2 times multiplier to their score.

The user's tight end gets a 2.5 times multiplier to their score.

The user's wide receiver gets a 2 times multiplier to their score.

All points from touchdowns scored by the user's tight end get a 3 times multiplier.

All points the user's kicker scores from made field goals longer than 40 yards get a 2.5 times multiplier.

For the selected player (entity), every incomplete pass, which is targets minus receptions, is worth 3 points.

Each rushing attempt by the user's running back is worth 1 point.

If the user's defense allows 35 or more points, this card (modifier) is worth 30 points.

For the user's quarterback, all passing yards and passing touchdowns get a 1.5 times multiplier, while all rushing yards and rushing touchdowns get a 0.5 times multiplier. For the selected player (entity), each reception counts as 3 points.

If the user's defense's team wins the game, this card (modifier) is worth 15 points.

All missed field goals and extra points are now worth 10 points instead of negative points.

For the selected player (entity), the points from rushing and receiving yards get a 2 times multiplier and points from rushing and receiving touchdowns get a 0.5 times multiplier.

All points from touchdowns scored by the user's defense get a 5 times multiplier.

Every turnover by the user's quarterback is worth 8 points instead of negative 2 points.

If the user's quarterback completes a throw of 50 yards or more, this card (modifier) is worth 30 points.

The user's quarterback gets a 0.25 times multiplier to their score while all running backs in the user's lineup get a 1.75 times multiplier to their score.

All players (entities) playing at home get a 1.25 times multiplier to their score while all players who are playing on the road get a 0.75 times multiplier to their score.

All running backs in the user's lineup get a 1.5 times multiplier while all wide receivers and tight ends in the user's lineup get a 0.5 times multiplier.

If the selected player (entity) has at least 250 passing yards and at least 20 yards, this card (modifier) is worth 30 points.

If the user's defense holds the opposing team to single-digit scoring, add an additional 30 points to the user's defense score.

If the selected player (entity) does not score a receiving touchdown, they get a 2 times multiplier on points from their receiving yards. However, if they do score a receiving touchdown, this card (modifier) does nothing.

Each incomplete pass by the quarterback is worth 1 point.

All non-quarterback players (entities) in the user's lineup on the same football team as the user's quarterback get a 1.25 times multiplier to their score.

If the selected player (entity) plays less than 30 offensive snaps, they get a 3 times multiplier to their score.

If the selected player (entity) has at least 80 rushing yards and at least 40 receiving yards, this card (modifier) is worth 30 points.

Every sack caused by the user's defense gets a 4 times multiplier on that component of the defense score.

For the user's quarterback, all points from rushing yards and rushing touchdowns get a 2.5 times multiplier while all points from passing yards and passing touchdowns get a 0.25 times multiplier.

For the selected player (entity), every punt or kick return yard is worth 0.2 points and every punt or kick return touchdown is worth 18 points.

If the selected player (entity) has a reception of 40 yards or more, this card is worth 30 points.

Every interception and fumble recovery caused by the user's defense gets a 5 times multiplier on that component of the defense score.

For the selected player (entity), all points from rushing and receiving touchdowns get a 2 times multiplier, and all points from rushing and receiving yards get a 0.5 times multiplier.

For the selected player (entity), every completed pass is worth 1 point and every incomplete pass is worth negative 0.5 points.

Each receiving target is worth 3 points.

If the selected player (entity) has a run of 30 yards or more, this card (modifier) is worth 30 points.

All wide receivers and tight ends in the user's lineup get a 1.25 times multiplier to their score while all running backs in the user's lineup get a 0.5 times multiplier to their score.

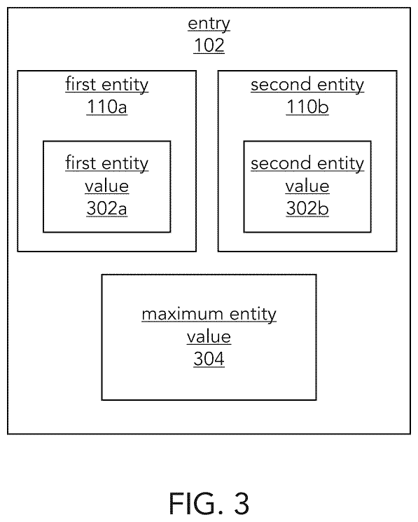

FIG. 3 illustrates an exemplary block diagram of an entry 102. As seen in FIG. 3, an entry 102 may include multiple entities 110, as shown as first entity 110a and second entity 110b. Each entity 110 may be associated with a respective entity value 302. The entity value 302 does not need to be the same between disparate entities 110. In this embodiment, first entity 110a includes a first entity value 302a, and second entity 110b includes a second entity value 302b.

As shown in FIG. 3, the entry 102 also includes a maximum entity value 304. The total value through adding up all entity values 302 cannot exceed this maximum entity value 304 for a single entry 102. In this example, the first entity value 302a, when added to the second entity value 302b, must be equal to or less than the maximum entity value 304.

In additional embodiments, more entities 110 may be included in an entry 102. The amount of entities 110 included in an entry 102 may be limited solely by the associated entity values 302 adding up to less than or equal to the maximum entity value 304. In one embodiment, the maximum value 304 corresponds to a user budget or salary cap for the entity, and the entity value 302 for each entity corresponds to an associated price for that entity (as described herein).

In still additional embodiments, the entry 102 may include a line-up, where specific positions need to, or can be, filled, by the entities 110. Using football as an example once again, these positions may include a quarterback, two running backs, two wide receivers, a tight end, a flex player, a kicker, and a defense. In some embodiments with specific positions to be filled, some of these positions may be left unfilled in order to preserve entity value 302 to fill other positions. For example, with respect to the football example above, a user may forego filling the tight end position in order to “purchase” a running back with a greater entity value 302 so that the total entity value 302 for the entry 102 does not exceed the maximum entity value 304.

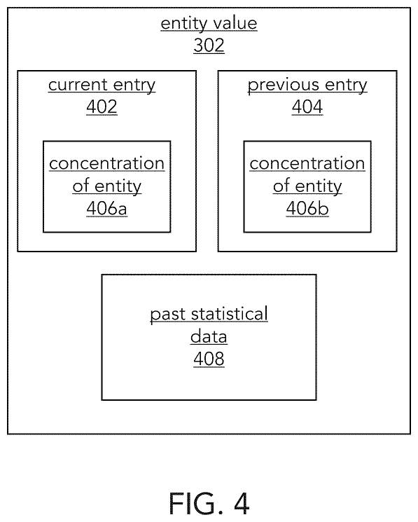

FIG. 4 illustrates an exemplary block diagram of an entity value 302 for a given entity. Specifically, FIG. 4 illustrates the ways in which the entity value 302 may be calculated. In some embodiments, the entity value 302 is based on a total supply and demand for the entity 110 in a game in which a current entry 402 is taking part (e.g., a current or upcoming football game, in the case of football). For example, the game may see a certain concentration of entity 406a for a specific entity 110 that is greater than that of other entities. This may either be because the entity 110 is desirable, or because the entity value 302 is considered low for the entity 110, making it a good deal. In this case, the entity value 302 for this desired entity 110 may increase.

Contra, a concentration of entity 406a for a specific entity 110 may be low—either due to a non-desire for that entity 110 throughout users in the game, or because the entity value 302 is too high. In this case, the entity value 302 for this undesirable entity 110 may decrease.

In some embodiments, the entity value 302 is based on a total supply and demand for the entity 110 in a game in which a previous entry 404 took part. This previous game (or games) may have shown a concentration of entity 406b for a specific entity 110 that was greater than that of other entities. This may have been either because the entity 110 was desirable, or because the entity value 302 was considered low for the entity 110, thus making it a good deal. In either case, this data from the previous entry 404 may be used to increase the entity value 302 for this entity 110 in a current entry 402.

Contra, the previous game (or games) may have shown a concentration of entity 406b for a specific entity 110 to be low—either due to a non-desire for that entity 110 in previous games, or because the entity value 302 was too high. In this case, the entity value 302 for this previously undesirable entity 110 may decrease in a current entry 402.

In additional embodiments, the entity value 302 for a given entity may be based on past statistical data 408. This past statistical data 408 may include statistics about the entity 110 itself, such as performance in metrics being measured to accrue points in the game (which may include a past attribute score(s)). This past statistical data 408 may also include factors, such as injury or probability of being played, when using the example of football.

The entity value 302 need not be limited to one of the above embodiments. The entity value 302 may be formulated through any combination of the current entry 402, a previous entry 404, and past statistical data 408.

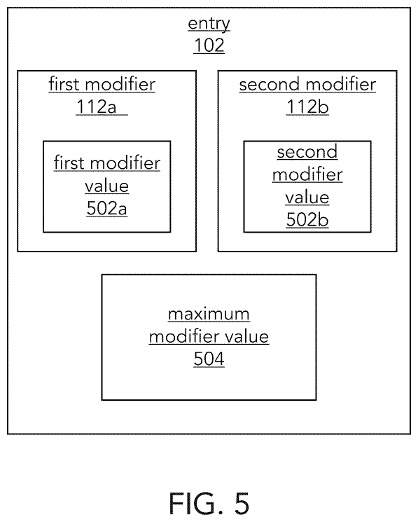

FIG. 5 illustrates an additional exemplary block diagram of an entry 102. As seen in FIG. 5, an entry may include multiple modifiers 112, as shown as first modifier 112a and second modifier 112b. Each modifier 112 may be associated with a respective modifier value 502. The modifier value 502 does not need to be the same between disparate modifiers 112. In this embodiment, first modifier 112a includes a first modifier value 502a, and second modifier 112b includes a second modifier value 502b.

As shown in FIG. 5, the entry 102 also includes a maximum modifier value 504. The total value through adding up all modifier values 502 cannot exceed this maximum modifier value 504 for a single entry 102. In this example, the first modifier value 502a, when added to the second modifier value 502b, must be equal to or less than the maximum modifier value 504.

In additional embodiments, more modifiers 112 may be included in an entry 102. The amount of modifiers 112 included in an entry 102 may be limited solely by the associated modifier values 502 adding up to less than or equal to the maximum modifier value 504. In one embodiment, the maximum modifier value 504 corresponds to a user budget for the modifier(s), and the modifier value 502 for each modifier corresponds to an associated price for that modifier (as described herein).

The modifiers 112 may affect a single entity 110. The modifiers 112 may also affect an entire team (either the team on which the player is a part of, or the line-up of entities within the entry made by the user). Using the example of football once again, the modifiers 112 may affect specific positions within a line-up (i.e., quarter back, running back, wide receiver, etc.). The modifiers 112 may also affect only the offense or only the defense. The modifiers 112 may also affect entities 110 having real-world interrelations to one another (i.e., all entities 110 that are on the same real-world team as the quarterback).

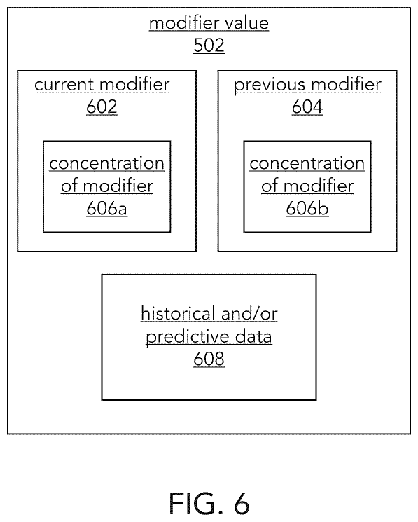

FIG. 6 illustrates an exemplary block diagram of a modifier value 502 for a given modifier. Specifically, FIG. 6 illustrates the ways in which the modifier value 502 may be calculated. In some embodiments, the modifier value 502 is based on a total supply and demand for the modifier 112 in a game in which a current entry 602 is taking part. The game may see a certain concentration of modifier 606a for a specific modifier 112 that is greater than that of other modifiers. This may either be because the modifier 112 is desirable, or because the modifier value 502 is considered low for the modifier 112, making it a good deal. In this case, the modifier value 502 for this desired modifier 112 may increase.

Contra, a concentration of modifier 606a for a specific modifier 112 may be low—either due to a non-desire for that modifier 112 throughout users in the game, or because the modifier value 502 is too high. In this case, the modifier value 502 for this undesirable modifier 112 may decrease.

In some embodiments, the modifier value 502 is based on a total supply and demand for the modifier 112 in a game in which a previous entry 604 took part. This previous game (or games) may have shown a concentration of modifier 606b for a specific modifier 112 that was greater than that of other modifiers. This may have been either because the modifier 112 was desirable, or because the modifier value 502 was considered low for the modifier 112, thus making it a good deal. In either case, this data from the previous entry 604 may be used to increase the modifier value 502 for this modifier 112 in a current entry 602.

Contra, the previous game (or games) may have shown a concentration of modifier 606b for a specific modifier 112 to be low—either due to a non-desire for that modifier 112 in previous games, or because the modifier value 502 was too high. In this case, the modifier value 502 for this previously undesirable modifier 112 may decrease in a current entry 602.

In additional embodiments, the modifier value 502 may be based on historical and/or predictive data 608. This historical and/or predictive data may include data about how users in the game have implemented modifiers 112 with specific entities 110, and then adjust the modifier 112 (either the modifier value, or the modifier itself in order to properly weight the points generated as strategies are formed) in order to more evenly balance the game for all users. This historical and/or predictive data 608 may also take into account real-world information about the entities 110. For example, if a specific modifier 112 is often played with a specific entity 110, but that entity is on injured reserve for the week, that modifier 112 may be predicted to be less desirable, and thus the modifier value 502 may decrease.

FIG. 7 illustrates an exemplary block diagram of an attribute 202. Specifically, while using football as an example, FIG. 7 illustrates a non-exhaustive list of possible attributes 202 that may be tracked for obtaining an attribute score within a game. Furthermore, any combination of the forthcoming attributes 202 may be used within a single entry 102 and/or for a single entity 110.

In some embodiments, the attribute 202 is touchdowns scored. According to some embodiments, the attribute 202 is touchdown passes. The attribute 202 may be touchdown rushes. In some embodiments, the attribute 202 is touchdown passes further or shorter than a predetermined distance. According to some embodiments, the attribute 202 is touchdown rushes further or shorter than a predetermined distance.

The attribute 202 may be kick returned further than a predetermined distance. In some embodiments, the attribute 202 is passing yards. According to some embodiments, the attribute 202 is rushing attempts. The attribute 202 may be rushing yards. In some embodiments, the attribute 202 is field-goals made. According to some embodiments, the attribute 202 is field-goals missed.

The attribute 202 may be tackles. In some embodiments, the attribute 202 is fumbles. According to some embodiments, the attribute 202 is fumble recoveries. The attribute 202 may be incomplete sacks. In some embodiments, the attribute 202 is turnovers.

According to some embodiments, the attribute 202 is incomplete passes. The attribute 202 may be complete passes. In some embodiments, the attribute 202 is interceptions. According to some embodiments, the attribute 202 is receptions. The attribute 202 may be the number of receiving targets.

In some embodiments, the attribute 202 is the offensive score. According to some embodiments, the attribute 202 is the defensive score. The attribute 202 may be the overall score.

In some embodiments, the attribute 202 is the number of offensive snaps. According to some embodiments, the attribute 202 is punt return yards. The attribute 202 may be kick return yards.

In some embodiments, the attribute 202 is single run yardage. According to some embodiments, the attribute 2302 is single pass yardage. The attribute 202 may be single field-goal yardage.

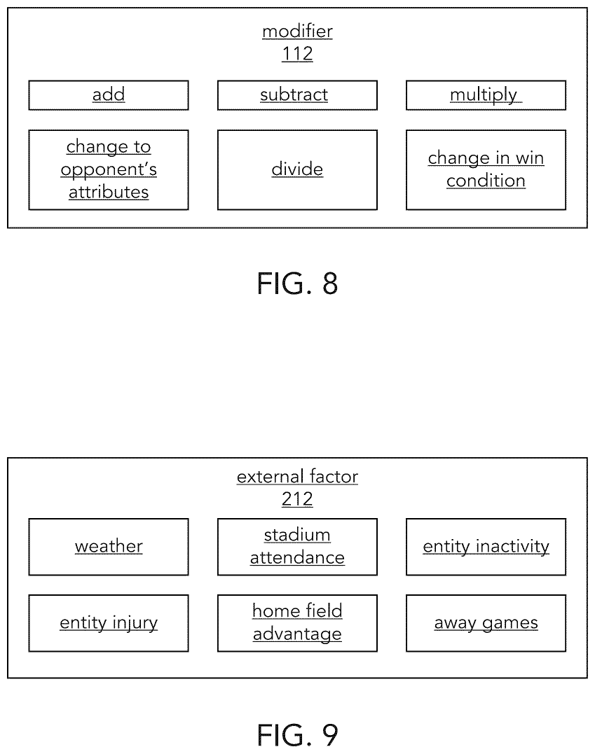

FIG. 8 illustrates a block diagram of a modifier 112, according to some embodiments. Specifically, FIG. 8 illustrates the way in which the modifier 112 may be used in conjunction with the computed attribute score 206 in order to generate the modified attribute score 208. Any of the forthcoming methods of using a modifier 112 may be used in isolation or in conjunction with one another.

In some embodiments, the modifier 112 imparts a calculation onto the computed attribute score 206. In some embodiments, the modifier 112 adds points to the computed attribute score 206 to generate the modified attribute score 208. According to some embodiments, the modifier 112 subtracts points from the computed attribute score 206 to generate the modified attribute score 208. Subtracting points may also be considered a form of addition, whereby the modifier 112 is adding negative points to the computed attribute score 206 to generate the modified attribute score 208.

The modifier 112 may multiply the computed attribute score 206 by some value in order to generate the modified attribute score 208. In some embodiments, the modifier 112 divides that computed attribute score 206 by some value in order to generate the modified attribute score 208. Dividing the computed attribute score 206 by some value may also be considered a form of multiplication, whereby the modifier 112 multiplies the computed attribute score 206 by a value between zero and one in order to generate the modified attribute score.

In some embodiments, the modifier 112 implements a change to an opponent's attributes. In these embodiments, the user is not modifying their own entry 102, but rather the entry of another user that they are playing in a game. The user may be able to modify the attributes 202 being monitored for an entry of the other user in order to gain an advantage over their opponent.

In additional embodiments, the modifier 112 changes the win condition of the game entirely. Using the example of football, the user may specifically choose the worst entities 110 possible in order to generate a low overall score, and then use a corresponding modifier 112 to change the win condition so that the lowest score is the winner.

FIG. 9 illustrates a block diagram of an external factor 212, according to some embodiments. As disclosed above, some of the factors 210 used when gathering real-time data 104 include external factors 212. These external factors 212 include factors 210 that are not directly correlated with an attribute 202, but may still have an effect on an attribute score 204 generated by the attribute 202.

The external factors 212 may include the weather, entity inactivity, or entity injury. Using the example of football, snowy or rainy weather may see an uptick in passing yards and a decrease in rushing yards, thus influencing any points generated by either. Entity inactivity may indicate that the entity 110 has not been performing at a high level, or has not been practicing as often, and thus the performance may suffer. Entity injury is similar, but with the added variable of not knowing what lasting implications the injury may have for the entity 110.

The external factors 212 may also include circumstances that may affect the entities 110 mentally. These external factors 212 may include such things as stadium attendance, home field advantage, and away games. Low stadium attendance may affect the self-esteem of the players (particularly the home team), and cause a lapse in their potential for scoring points. Contra, high stadium attendance may increase the overall energy for both teams, causing an increase in scoring potential. This may be especially true for home team, giving them a home field advantage. Players playing in away games may have a decrease in scoring, because any audience in attendance is likely to be rooting for the home team.

Accordingly, external factors may relate to a modifier 112 that look to modify an attribute score by accounting for such circumstances. For example, where there is low stadium attendance, a multiplier may look to increase the computed attribute score of an entity 110 to counter the predicted low-performance.

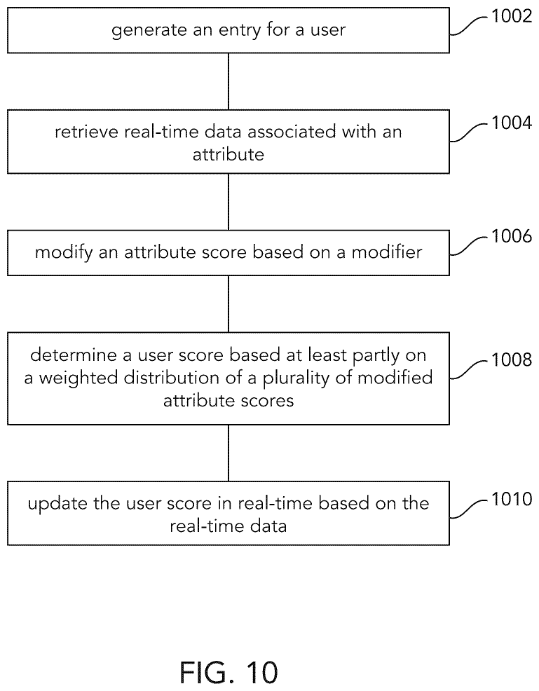

FIG. 10 illustrates a flow chart depicting a method of generating a user score, according to some embodiments. The method may include generating an entry for a user (at step 1002). The user may select one or more entities and one or more modifiers to associate with any of the chosen entities, or the entry as a whole. Using the example of football, the user may select one or more players to create a line-up. The user may also select modifiers, that may be presented as cards for example (e.g., virtually), that modify any scoring done by the players in order to increase (or augment, or change, etc.) the user's in-game score (e.g., the user score).

In some embodiments, the method includes retrieving real-time data associated with an attribute (at step 1004). When a real-world event is occurring, data associated with the entities may be updated in real-time, thus impacting the user score while the events occur. Again, using the example of football, after a running back rushes the ball an amount of yards (e.g., attribute), the score accrued for rushing yards for that player will be added to the user score (after modification through the weighted distribution and any in-play modifiers).

According to some embodiments, the method includes modifying an attribute score based on a modifier (at step 1006). When computed attribute scores are created through the combination of a weighted distribution and the real-time data, any in-play modifiers that influence those specific computed attribute scores (either through association with the entity for which the computed attribute score was generated, or the team as a whole) will be used to modify the computed attribute scores, thus generating a modified attribute score.

The method may include determining a user score based at least partly on a weighted distribution of a plurality of modified attribute scores (at step 1008). In order to balance different real-world values varying by quite a bit in pure numbers (i.e., a running back will likely rush for a lot more yards than a quarterback will throw touchdowns, numerically), a weighted distributed may be imparted on the real-time data in order to balance the game, so that all entities are capable of contributing to the entry.

In some embodiments, the attributed score is first weighted to determine the computed attribute score (step 1008), and then corresponding modifier(s) are applied (step 1006) to generate the modified attribute score, which may then be used (at least in part) to determine the user score. As described herein, unmodified modified attribute scores may be included in determining the user score. In some embodiments, step 1008 occurs prior to step 1006. In other embodiments, step 1008 occurs after step 1006. In either embodiment, the computations that occur may result in the same end value (user score).

In some embodiments, the method includes updating the user score in real-time based on the real-time data (at step 1010). Any of the steps above or below may be updated continually as the real-time data is generated. Again turning to the example of football, after every play, the user score may be adjusted based on what attribute scores changed during that play. In alternate embodiments, the user score may only be adjusted after the end of a game, after the end of a week of play, or after the entire season. In some embodiments, the user score may further include unmodified scores, either in isolation or in combination with the modified scores as detailed in the aggregation step 1104 below.

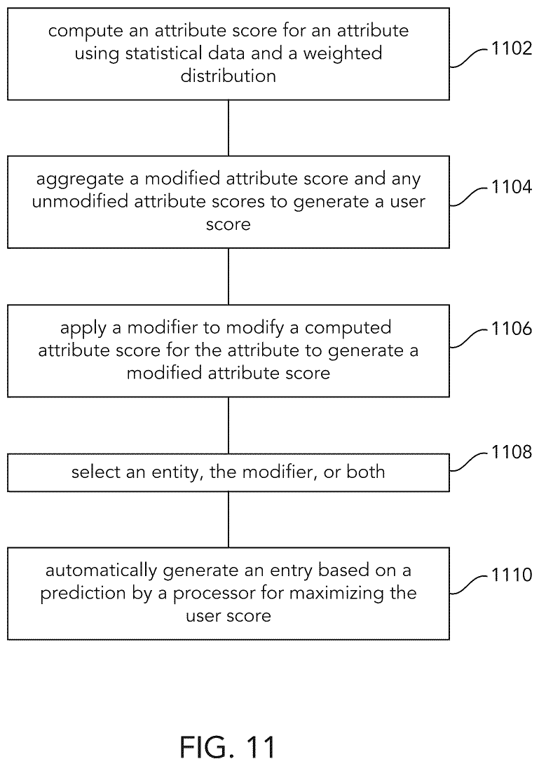

FIG. 11 illustrates a flow chart depicting a method of computing a user score, according to some embodiments. In some embodiments, the method includes computing an attribute score for an attribute using statistical data and a weighted distribution (at step 1102). As disclosed above, the statistical data may be incongruous between different statistics (i.e., a running back will likely rush for a lot more yards than a quarterback will throw touchdowns, numerically). Through the application of a weighted distribution to this statistical data, a computed attribute score is generated, which evens out scoring between different monitored attributes.

According to some embodiments, the method includes aggregating a modified attribute score and any unmodified attribute scores to generate a user score (at step 1104). In some embodiments, the raw data associated with the attribute score may be aggregated with the modified attribute score in order to generate the total user score. In this way, certain metrics may be further balanced. In additional embodiments, this aggregation of scores may add an additional level of complexity and strategy for a user when choosing what scores to prioritize for their line-up.

The method may include applying a modifier to modify a computed attribute score for the attribute to generate a modified attribute score (at step 1106). As disclosed above, once a computed attribute score is generated through the real-time data and the weighted distribution, any modifiers that are applicable to that specific computed attribute score may be implemented on top of that computed attribute score in order to generate a modified attribute score.

In some embodiments, the method includes selecting an entity, the modifier, or both (at step 1108). When creating an entry, the user may choose one or more entities, one or more modifiers to be played on those one or more entities (or the line-up as a whole). Based on values of the entities and modifiers, the user may prioritize one over the other if they were to share the same maximum value pool. In some embodiments, selecting the entity, the modifier, or both occurs prior to any computations performed in the steps listed above and below.

According to some embodiments, the method includes automatically generating an entry based on a prediction by a processor for maximizing the user score (at step 1110). Past historical data may be used to predict a projected value for each entity. This projected value may be indicative of how many points (attribute score) are expected to come from that entity during the next event the entity takes part in. In some embodiments, the processor is able to take this one step further, forming a full line-up based on these predictions. The processor may be further able to implement modifiers on the entities in the line-up to form a full entry. In some embodiments, this may assist a user with forming a line-up for use in a game. In additional embodiments, this may create a single-player experience, where the user is able to face-off against the processor while both are still using the constraints of the game as a whole in their play. In some embodiments, automatically generating the entry based on the prediction by the processor for maximizing the user score occurs in addition to or alternatively to the user selecting the entity, the modifier, or both as detailed in step 1108 above.

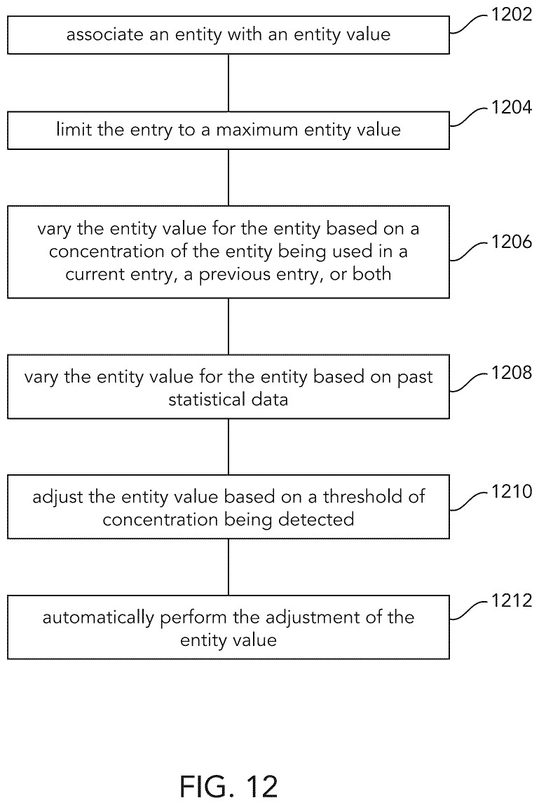

FIG. 12 illustrates a flow chart depicting a method of ascertaining an entity value, according to some embodiments. In some embodiments, the method includes associating an entity with an entity value (at step 1202). As described in FIG. 4 above, entity values may be associated with the entities based on a variety of factors, such as supply and demand or past statistical data. An initial entity value (step 1202) may be based on the entity value from a previous event or game (e.g., previous week in the case of football).

According to some embodiments, the method includes limiting the entry to a maximum entity value (at step 1204). As described in FIG. 3 above, the entity values for all entities within an entry must be equal to or less than a maximum entity value. This may cause users to implement further strategy when creating a line-up, either through prioritizing different positions based on value, or foregoing some positions entirely in order to maximize potential in other positions. An entry including multiple entities associated with entity values as detailed in the steps below may not exceed the maximum entity value, and the entities that may be selected in tandem with one another without exceeding this maximum entity value may change based on the change in their individual entity values over time (for example, see steps 1206, 1208, 1210, and 1212). In additional or alternative embodiments, the user may exceed the maximum entity value, but their score may suffer a penalty in response to this overage.

The method may include varying the entity value for the entity based on a concentration of the entity being used in a current entry, a previous entry, or both (at step 1206). As detailed in FIG. 4 above, the entity value may be based on a total supply and demand for the entity in a game in which a current entry is taking part. The game may see a certain concentration of entity for a specific entity that is greater than that of other entities. This may either be because the entity is desirable, or because the entity value is considered low for the entity, making it a good deal. In this case, the entity value for this desired entity may increase.

Contra, a concentration of entity for a specific entity may be low—either due to a non-desire for that entity throughout users in the game, or because the entity value is too high. In this case, the entity value for this undesirable entity may decrease.

In some embodiments, the entity value is based on a total supply and demand for the entity in a game in which a previous entry took part. This previous game (or games) may have shown a concentration of entity for a specific entity that was greater than that of other entities. This may have been either because the entity was desirable, or because the entity value was considered low for the entity, thus making it a good deal. In either case, this data from the previous entry may be used to increase the entity value for this entity in a current entry.

Contra, the previous game (or games) may have shown a concentration of entity for a specific entity to be low—either due to a non-desire for that entity in previous games, or because the entity value was too high. In this case, the entity value for this previously undesirable entity may decrease in a current entry.

In some embodiments, the method includes varying the entity value for the entity based on past statistical data (at step 1208). As also detailed in FIG. 4 above, this past statistical data may include statistics about the entity itself, such as performance in metrics being measured to accrue points in the game. This past statistical data may also include factors, such as injury or probability of being played, when using the example of football.

According to some embodiments, the method includes adjusting the entity value based on a threshold of concentration being detected (at step 1210). Based on the supply and demand for an entity as detailed above at step 1206, the entity value may be adjusted in order to facilitate the prevention or reduction of too many users playing the same strategy with specific entities, as well as to balance the game as a whole.

The method may include automatically performing the adjustment of the entity value (at step 1212). While data comes in indicative of supply and demand tendencies, the entity values may be automatically adjusted (e.g., in real-time). In games where users are permitted to change line-ups at different time intervals, this may increase or decrease the entity values for different entities between these time periods, thus causing users to change their strategy to prevent overshooting the maximum entity value associated with their entry.

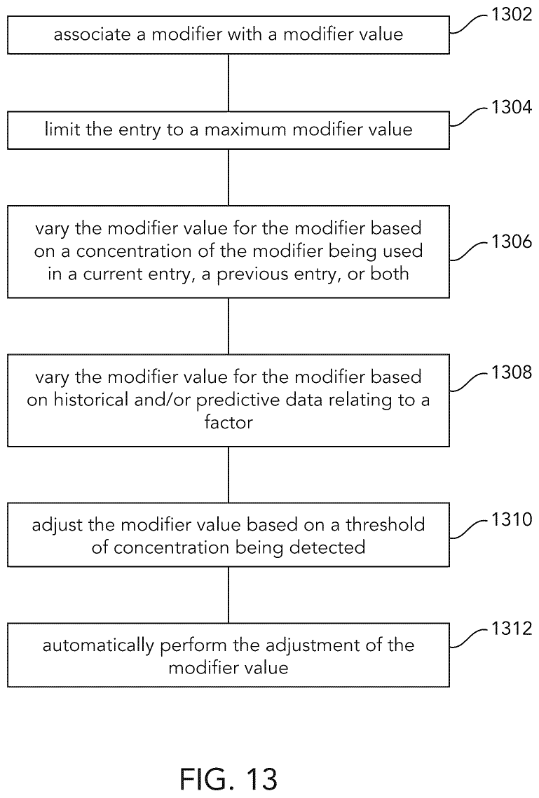

FIG. 13 illustrates a flow chart depicting a method of ascertaining a modifier value, according to some embodiments. In some embodiments, the method includes associating a modifier with a modifier value (at step 1302). As described in FIG. 6 above, modifier values may be associated with the modifiers based on a variety of factors, such as supply and demand or historical and/or predictive data. An initial modifier value (step 1302) may be based on the modifier value from a previous event or game (e.g., the previous week in the case of football).

According to some embodiments, the method includes limiting the entry to a maximum modifier value (at step 1304). As described in FIG. 5 above, the modifier values for all modifiers within an entry must be equal to or less than a maximum modifier value. This may cause users to implement further strategy when creating a line-up, either through prioritizing different positions based on projected score, or creating a line-up revolving around specific modifiers (such as a modifier for players that are playing away from home that week getting an increase to their points). An entry including multiple modifiers associated with modifier values as detailed in the steps below may not exceed the maximum modifier value, and the modifiers that may be selected in tandem with one another without exceeding this maximum modifier value may change based on the change in their individual modifier values over time (for example, see steps 1306, 1308, 1310, and 1312). In additional or alternative embodiments, the user may exceed the maximum modifier value, but their score may suffer a penalty in response to this overage.

The method may include varying the modifier value for the modifier based on a concentration of the modifier being used in a current entry, a previous entry, or both (at step 1306). As described in FIG. 6 above, the modifier value may be based on a total supply and demand for the modifier in a game in which a current entry is taking part. The game may see a certain concentration of modifier for a specific modifier that is greater than that of other modifiers. This may either be because the modifier is desirable, or because the modifier value is considered low for the modifier, making it a good deal. In this case, the modifier value for this desired modifier may increase.

Contra, a concentration of modifier for a specific modifier may be low—either due to a non-desire for that modifier throughout users in the game, or because the modifier value is too high. In this case, the modifier value for this undesirable modifier may decrease.

In some embodiments, the modifier value is based on a total supply and demand for the entity in a game in which a previous entry took part. This previous game (or games) may have shown a concentration of modifier for a specific modifier that was greater than that of other modifiers. This may have been either because the modifier was desirable, or because the modifier value was considered low for the modifier, thus making it a good deal. In either case, this data from the previous entry may be used to increase the modifier value for this modifier in a current entry.

Contra, the previous game (or games) may have shown a concentration of modifier for a specific modifier to be low—either due to a non-desire for that modifier in previous games, or because the modifier value was too high. In this case, the modifier value for this previously undesirable modifier may decrease in a current entry.

In some embodiments, the method includes varying the modifier value for the modifier based on historical and/or predictive data relating to a factor (at step 1308). As also described in FIG. 6 above, this historical and/or predictive data may include data about how users in the game have implemented modifiers with specific entities, and then adjust the modifier in order to more evenly balance the game for all users. This historical and/or predictive data may also take into account real-world information about the entities. For example, if a specific modifier is often played with a specific entity, but that entity is on injured reserve for the week, that modifier may be predicted to be less desirable, and thus the modifier value may decrease.

According to some embodiments, the method includes adjusting the modifier value based on a threshold of concentration being detected (at step 1310). Based on the supply and demand for a modifier as detailed above at step 1306, the modifier value may be adjusted in order to facilitate the prevention or reduction of too many users playing the same strategy with specific modifiers, as well as to balance the game as a whole.

The method may include automatically performing the adjustment of the modifier value (at step 1312). While data comes in indicative of supply and demand tendencies, the modifier values may be automatically adjusted (e.g., in real-time). In games where users are permitted to change line-ups at different time intervals, this may increase or decrease the modifier values for different modifiers between these time periods, thus causing users to change their strategy to prevent overshooting the maximum modifier value associated with their entry.

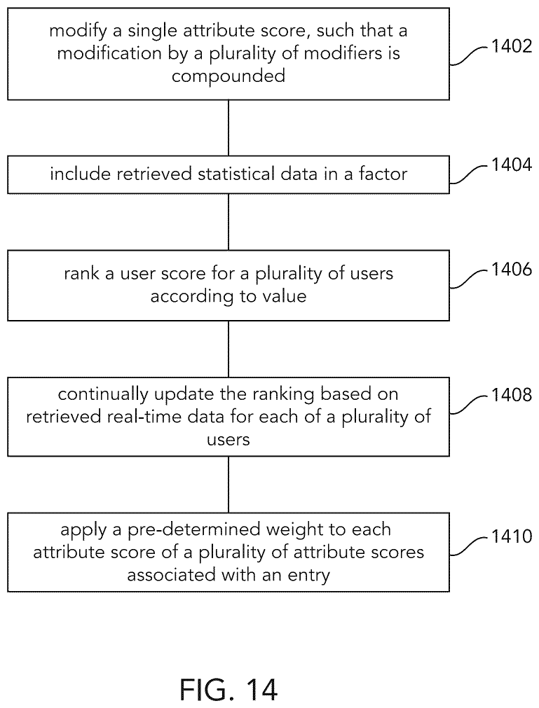

FIG. 14 illustrates a flow chart depicting a method of modifying a score, according to some embodiments. In some embodiments, the method includes modifying a single attribute score, such that a modification by a plurality of modifiers is compounded (at step 1402). Multiple modifiers may impact a single entity. Turning to football as an example once again, a running back may have its score compounded in multiple forms—perhaps through a pure multiplier on all rushing yards, combined with an overall multiplier for being on the same real-world team as the quarterback.

According to some embodiments, the method includes including retrieved statistical data in a factor (at step 1404). Factors not necessarily associated with the raw numerical data associated with an attribute score may also be included and impart some weight on the attribute score. These factors may be external factors, such as those described above in FIG. 9.

The method may include ranking a user score for a plurality of users according to value (at step 1406). In a game setting, more than one user may participate. Each user generates a user score, either through the attribute score, the computed attribute score, the modified attribute score, or an aggregation of any or all of these scores, based on attributes associated with entities chosen by the user. These user scores may then be ranked by value in order to form a leaderboard and declare a winner among the users.

In some embodiments, the method includes continually updating the ranking based on retrieved real-time data for each of a plurality of users (at step 1408). As real-time data comes in and affects the computed attribute score (and thereby the modified attribute score), user scores may be adjusted. As these user scores are adjusted, their rankings against other user scores may change. The rankings, and thus leaderboard, including these user scores, may then be updated continually based on this incoming real-time data.

According to some embodiments, the method includes applying a pre-determined weight to each attribute score of a plurality of attribute scores associated with an entry (at step 1410). As disclosed above, the attribute scores may be incongruous between different statistics (i.e., a running back will likely rush for a lot more yards than a quarterback will throw touchdowns, numerically). Through applying a pre-determined weight to each attribute score, a computed attribute score is generated, which evens out scoring between different monitored attributes. In some embodiments, applying the pre-determined attribute score of a plurality of attribute scores associated with an entry occurs prior to steps 1402, 1404, 1406, and 1408 as detailed above.

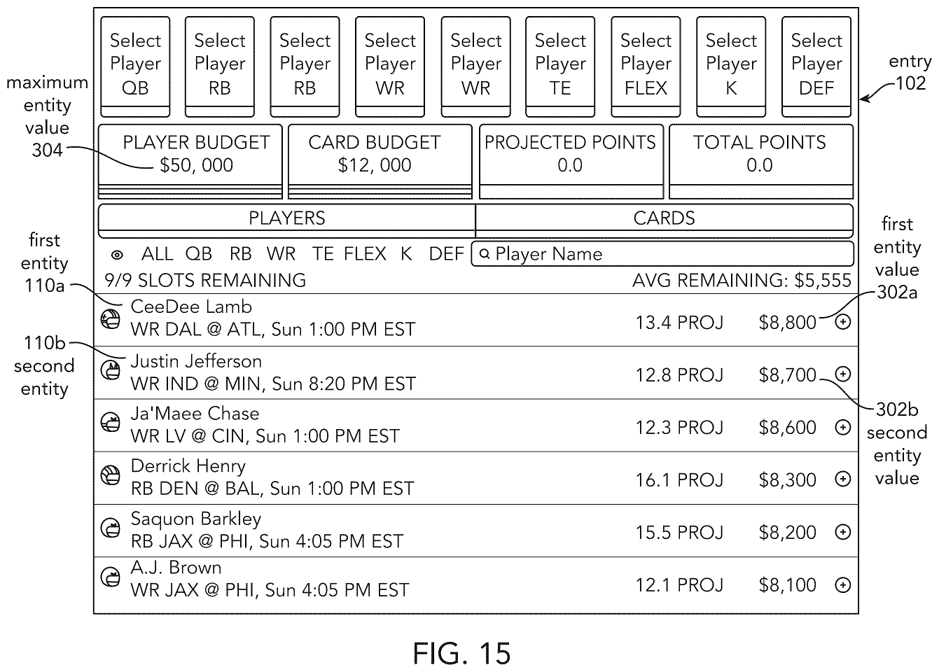

FIG. 15 illustrates a diagram of a graphical user interface (GUI) including entities 110 prior to selection, according to some embodiments. Specifically, shown in FIG. 15 is a GUI for a user to make an entry 102. In this figure, on the left side of the GUI, is a maximum entity value 304, here named a player budget. This is the amount of currency a user may spend on entities to create their team for the entry 102. Shown and labeled are a first entity 110a and a second entity 110b. Additional entities (four additional entities in this figure) are shown but not labeled to facilitate the reading of this figure.

On the right side of the GUI, associated entity values are shown. A first entity value 302a and a second entity value 302b are illustrated, and seen on the same line as the first entity 110a and the second entity 110b, respectively, indicating that the first entity value 302a is associated with the first entity 110a, and the second entity value 302b is associated with the second entity 110b.

Additional information is provided on the GUI but not labeled, again to improve comprehension of the figure as a whole. At the top of the GUI are slots for placement of entities 110. Using the example of fantasy football once again, the slots are specified for specific types of entities 110. In this example, the slots are designated for one quarterback, two running backs, two wide receivers, one tight end, one flex player, one kicker, and a defense. Only entities that fall into the correct designation may fill the respective entity slot.

As can be seen above the entities 110, the entities may be sorted based on position or unsorted leaving all entities on the screen. A search bar is also present to allow for the user to search for a specific entity 110 by name. Seen above the entity values 302 is an average remaining, which indicates, on average, how much entity value may be spent on each remaining entity 110 to fill all of the entity slots without surpassing the maximum entity value 304.

Additional information may be provided along with the entities 110. As shown in FIG. 15, the position and team that the entity 110 plays for is displayed, along with the team they will be facing next, and the time and date of such an event. On the right side of the screen, next to the entity values 302, a projected score is shown. This projection is based on predictive data, both of for the entity 110 and for the team matchup.

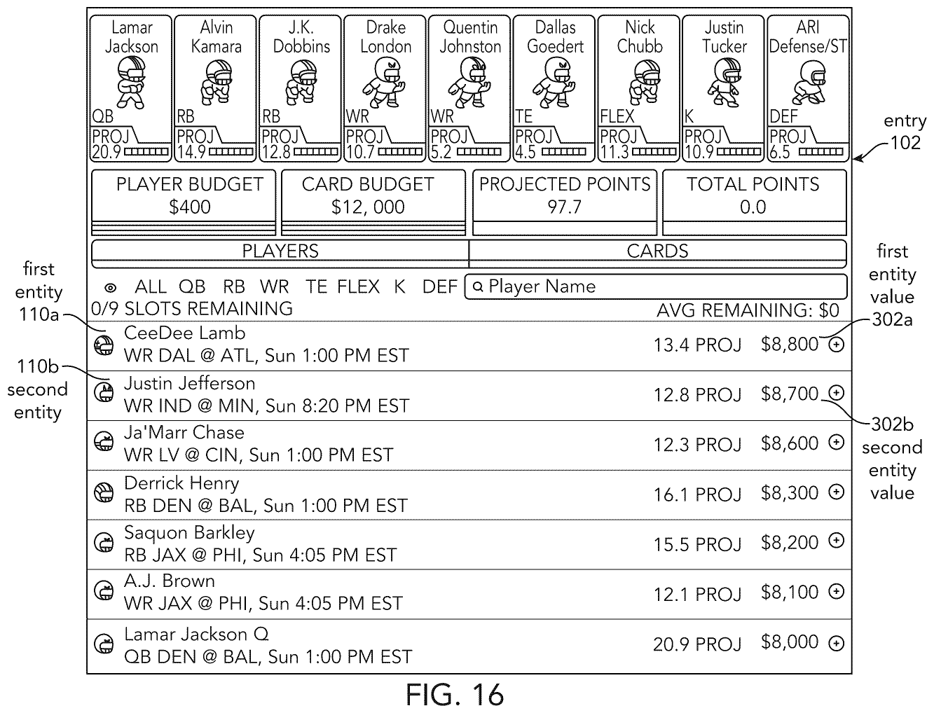

FIG. 16 illustrates a diagram of a GUI including entities 110 after selection, according to some embodiments. In this example, the entity slots at the top of the GUI have been filled with entities 110. These representations of the entities display the name of the entity, the position of the entity, the projected score for the entity, and a graphical visualization of the entity. This visualization of the entity may also be animated, moving between two or more states to give the appearance of a graphics interchange format (GIF) image.

The visualization of the entity may also indicate status affects for the entity—for example, the visualization of the entity may see the entity holding their leg, as if in pain, indicating that the entity is injured, or sitting on a bench, indicating that the entity may not be playing in the upcoming game (sometimes referred to as a healthy scratch).

The visualization of the entity may also include information about the performance of the entity—for example, the entity might be surrounded by flames, as if powering up, in response to the entity performing very well, or might include the entity looking distraught, perhaps with overcast clouds and rain, indicating that the entity is performing poorly. These indications might be based on the raw performance of the entity, or based on the performance of the entity with respect to the projected points for the entity.

Also seen in FIG. 16, above the entities for selection by the user and below the filled entity slots are projected points and total points. The projected points may be indicative of how many points the user will earn based on adding together the projected points for each selected entity 110. The total points may be indicative of how many points the user actually earned based on the performance of the entities 110, i.e., the user score 106. In FIG. 16, the total points are displayed as zero, as the games had not yet been played at the time of rendering, so no actual score could be given to the user.

Also seen in FIG. 16 is the maximum entity value (player budget) has decreased, from $50,000 to $400, as a result of entities 110 being chosen and their entity values 302 being removed from the maximum entity value 304, thereby expressing to the user how much currency is left with which to purchase entities 110.

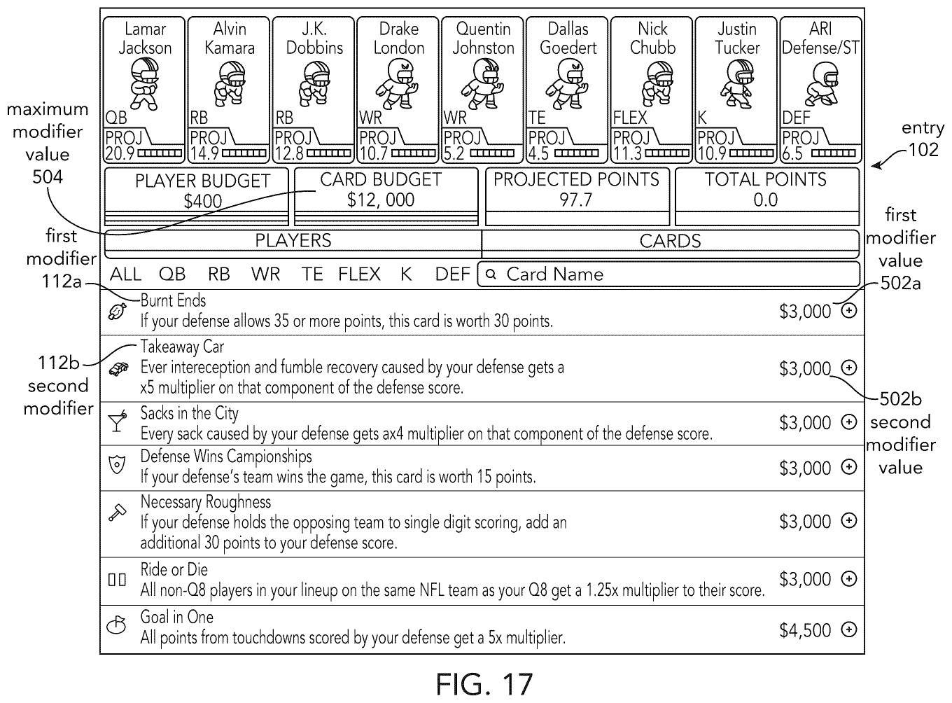

FIG. 17 illustrates a diagram of a GUI including modifiers prior to selection, according to some embodiments. In this figure, on the left side of the GUI, is a maximum modifier value 504, here named a card budget. This is the amount of currency a user may spend on modifiers 112 to create their team for the entry 102. Shown and labeled are a first modifier 112a and a modifier 112b. Additional modifiers (five additional modifiers in this figure) are shown but not labeled to facilitate the reading of this figure.

On the right side of the GUI, associated modifier values are shown. A first modifier value 502a and a second modifier value 502b are illustrated, and seen on the same line as the first modifier 112a and the second modifier 112b, respectively, indicating that the first modifier value 502a is associated with the first modifier 112a, and the second modifier value 502b is associated with the second modifier 112b.

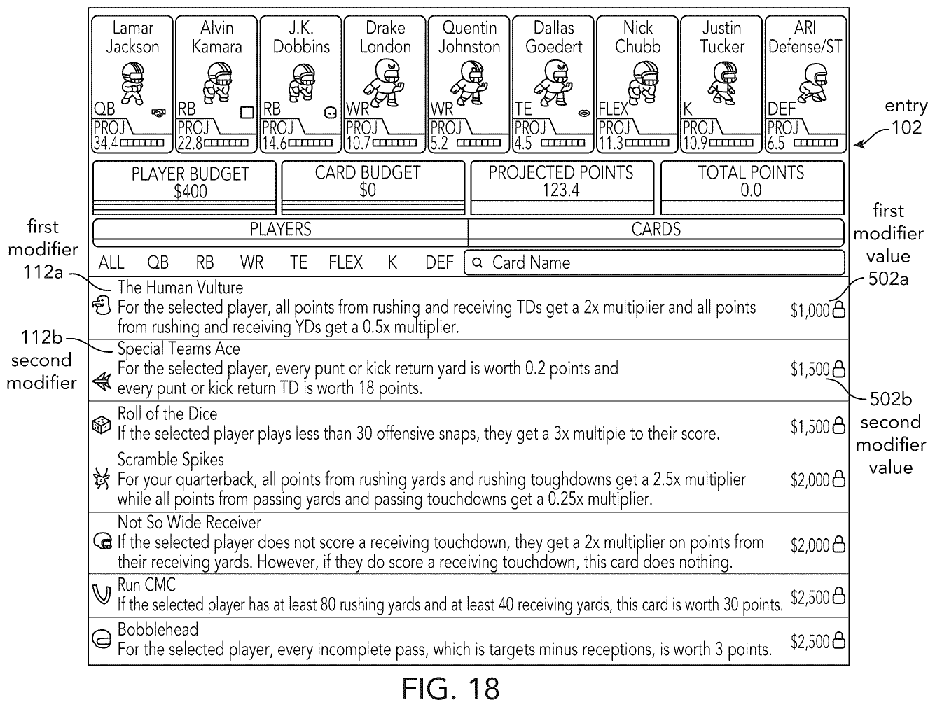

FIG. 18 illustrates a diagram of a GUI including modifiers after selection, according to some embodiments. With modifiers 112 being selected, small images may appear on the associated entity 110 on which the modifier 112 is being used. These images may be seen in the bottom right corner of the first, second, third, and sixth visualization of entities. While not shown in the figure, modifiers 112 that affect the entire team, or a condition other than that which affects a single entity 110, may be displayed beneath the visualization of entities as a whole.

As is also shown in FIG. 18, the projected points have changed. For the purposes of FIGS. 16-18, the same entities 110 have been shown in the entity slots. Prior to modification, the projected score (as seen in FIGS. 16 and 17) was 97.7 points. Now that modifiers 112 have been added to the entities 110, the projected score has increased to 123.4 points. This may indicate to the user how much return they may expect based on their chosen combination of modifiers 112 with their chosen combination of entities 110. Once again, these values are purely based upon predictive models based on past performance of the entities 110 along with the matchups between the entities 110 team and their opposition.

Also seen in FIG. 18 is the maximum modifier value (card budget) has decreased, from $12,000 to $0, as a result of modifiers 112 being chosen and their modifier values 502 being removed from the maximum modifier value 504, thereby expressing to the user how much currency is left with which to purchase modifiers 112. Examples of some of the possible modifiers are described in further detail in FIG. 2 above.

The forthcoming disclosure includes four different examples of how to implement the above disclosure in a real-world game. Each of these examples will pertain to fantasy football, but in other examples, other sports or competitive events may also use these variations. Additionally, each example may include common elements in the use of modifiers 112 and entities 110 in order to play and modify the game.

### Daily Fantasy Sports Example

A first example is a daily tournament or daily fantasy sports (DFS) format, which can share some similarities with the style of traditional daily fantasy football. In this example, a user may create a lineup. This may be split into a player lineup and a card lineup. In some examples, the player lineup and/or the card lineup will have a budget that the chosen players and/or cards must stay under, whereby each player and/or card has a price. According to some examples, at least one of these prices is dynamic.

The dynamic nature of the player and/or card pricing may be based on many possible options, such as the popularity, the rarity, and/or the projected value of the player and/or card. The dynamic nature of one or more of the prices may be affected by events in the real world. In some examples in the fantasy football format, this may take the form of a player having a lower cost due to an injury of the player in the real world. According to some examples, the value of a player and/or card is determined by using and/or pulling information from a third-party (i.e., independent) computing system. With this information, the price of the player and/or card may be adjusted.

In some examples, the price of a player and/or card is dependent on another player and/or card being chosen by a user. However, according to some examples, the price of a player and/or card is not dependent on another player and/or card. It may be possible to mix these formats, where the price of a first player and/or card depends on a second player and/or card. In such examples, the price of a third player and/or card need not be dependent on this second player and/or card. In still other examples, a second iteration of the first player and/or card (i.e., a player and/or card that is used by each of a first user and a second user) need not also depend on the second player and/or card. In fact, any additional iteration of a player and/or card need not depend on any other player and/or card, even where one iteration of the player and/or card does so. In some examples, the players and/or cards will have a secondary market outside of the game itself, where users may buy and sell players and/or cards. This may be another way the price of a player or card could dynamically change.

Randomness with a connection to the real world may additionally allow for fluctuations in the variability of the game. For example, the variability may be driven by the statistics of a real-world performance of an athlete. However, the cards may then add volatility to the statistics and/or adjust the price of a card and/or player. Further variability may then be added by changing the rules of the game, such as the win condition(s). In some examples, playing a certain card changes the rules of the game. According to the above example, it is possible to add variability to the game as a whole by inducing volatility in the win conditions, the cards, the price of the cards and/or players, and/or the statistics of the real-world performance of an athlete.

The types of cards and the things the cards do and/or modify may be wide-ranging. For example, the game may include cards that power up players and/or teams, power down players and/or teams, change negatives to positives, change positives to negatives, and/or change the win condition(s) of the game. In some examples, cards with the same and/or similar effects may “stack” on each other or may have effects that are separate from each other. For example, if two cards are played to affect a player, where one card doubles the points from a player and the second card doubles the points awarded from rushing yards of the player, in some instances, the player would receive a “stacked” effect where the rushing yard points would be doubled from the first card and doubled from the second card for a total effect of quadrupling the points from rushing yards and all other, non-rushing yard points would be doubled from the first card. In another instance, the player would have all of their points doubled or would have rushing yard points doubled, but the rushing points would not be “stacked” by being doubled twice. It should be understood, however, that these are only some examples of card effects and are not meant to be limiting as to what the cards may do.

The game may include representations of the players, such as visual representations, sometimes referred to as sprites. The sprites in the game may have multiple versions to represent aspects of the player, such as their real-world team, their injury status, and/or generally how they performed in their last competition compared to how they were expected to perform based on a projected score assigned to them prior to the competition. It is understood, however, that these are only some of the possible examples of how the sprite might represent a player. According to some examples, the sprite will change dynamically with the real-world status of the associated player. In some examples, the sprite is animated. According to some examples, the animation is a cyclical changing between two or more frames of still images.

In some examples, the daily tournament or DFS format of the game is open to the public and/or has available spots in the game filled in order of arrival to the game. This may take the form of the order of players arriving at a game location and/or joining the game virtually being the order in which the spots in the game will be filled. However, it should be understood that the places available in the game may be filled in any way. According to some examples, the game is a private game and/or tournament format. The private game and/or tournament format may allow for different rules, options, and/or variations of the game than the public format. For example, the private format may allow for changing such things as whether the cards “stack,” the player and/or card budget, and/or the players and/or cards available in the game. However, it should be understood that these may not be the only things that may be changed in the private format of the game. The ability to change the rules of the game may be open to at least one player and/or leader of the game.

### Season-Long Example

A second example of the game may be similar to a season-long fantasy football format. In this format, the user may pick their players, team, and/or cards for the entire season at the beginning of the game. According to some examples, a user is paired with another user each week, and their teams' total scores are compared at the end of the week to determine a winner. In some examples, the game includes a card deck that each user gets at the beginning of the game. The card deck may be the same for all of the users. According to some examples, each user is allowed to play a certain number of cards each week. In some examples, the cards may only be used once per season. According to some examples, the card deck is not the same for each player. This may allow players to bring in their own decks and/or to get additional cards throughout the season. The decks not being the same may allow for the buying and selling of cards inside and/or outside of the game and/or other forms of deck variability. All such card decks may be either physically presented or virtually represented.

In some examples, the cards may positively and/or negatively modify a player, card, and/or team. As previously mentioned, this may take the form of multipliers to a single player's score. However, it may also or instead take the form of negating and/or countering a card a user plays, applying a positive modifier for one statistic that generates points and/or applying a negative modifier for a different statistic that generates points, and/or only taking effect if another card is also played. It is understood, however, that these are only some of the examples of the effects the cards may have on the game.

In some examples, the cards may be played outside of the match the user is in, but within the game in another match the user is not in. For example, a first user may be in a match against a second user, and a third user may be in a match against a fourth user. The first user may play at least one card on one or more players, cards, and/or the entire team of the fourth user. This may also be possible if the first user is not in a match against anyone but still wants to play one or more cards on one or more players, cards, and/or the entire team of another user. This format may allow multiple users to “group attack” one or more other users, allowing the real world to again affect and/or add variability to the game. It should be understood, however, that this is only one example of a version of the game.

### Challenge Example

A third example of the game may be similar to if fantasy football had a “challenge” option. In some examples, this format allows multiple users to play the game as a group and/or individually. According to some examples, a challenge is set, and each user and/or group of users attempts to complete the challenge. In some examples, a user and/or group of users would attempt to perform better in the challenge than another user and/or group of users. These examples may allow for different challenges with different goals and/or win conditions. Examples of challenges may include attempting to score as many points as possible where the players the user may utilize are the same for every user, the cards the user may utilize are the same for every user, and/or the user and/or group of users must collectively score above a specified target score. However, these are only some examples of the form in which this third example of the game may take.

### Simulation Example

A fourth example of the game may be referred to as a standalone game. In some examples, this version of the game is based on simulations of the players chosen by the user. The user might not control the chosen player and/or players. According to some examples, an algorithm of the game simulates what a one-week score of the chosen player could be. The simulations may be based on the statistics of the chosen player over a specified period, such as a single competition, a season, a set of years, and/or a career. In some examples, the algorithms and/or the simulations are based on a statistical model, artificial intelligence (AI), machine learning, and/or neural nets. However, it should be understood that these are only some examples of how the fourth example may function. The fourth example of the game may include cards. In some examples, the card options are different and/or include additional cards, such as injuries, fatigue, and/or weather. However, it should be understood that these are only some examples of the forms the cards may take.

Included in the present disclosure is a system for determining a user score, the system including one or more processors. In some embodiments, the system includes one or more memories storing instructions that, when executed by the one or more processors, cause the system to perform operations. According to some embodiments, these operations include generating an entry for a user. The entry may include one or more entities, each entity associated with one or more attributes that are each correlated with a corresponding attribute score. In some embodiments, the entry includes one or more modifiers configured to modify a respective attribute score for at least one of the one or more attributes. According to some embodiments, the operations include retrieving real-time data associated with the one or more attributes for the one or more entities. The real-time data may include statistical data relating to at least some of the one or more attributes. In some embodiments, the real-time data includes one or more factors relating to at least some of the one or more modifiers. According to some embodiments, the operations include determining and updating the user score in real-time. Determining and updating the user score in real-time may be based on computing the attribute score for each of the one or more attributes using the statistical data and a weighted distribution thereby forming a computed attribute score. In some embodiments, determining and updating the user score in real-time is based on applying the one or more modifiers to modify the computed attribute score for the at least one of the one or more attributes to generate one or more modified attribute scores, wherein a modification by the at least some of the one or more modifiers is based on the one or more factors. According to some embodiments, determining and updating the user score in real-time is based on aggregating the one or more modified attribute scores and any unmodified attribute scores to generate the user score.

The entry may be generated based on a user selection of the one or more entities, one or more modifiers, or both. In some embodiments, at least part of the entry is generated automatically based on a prediction by the one or more processors for maximizing the user score.

According to some embodiments, each of the one or more entities is associated with an entity value, and wherein the entry is limited to a maximum entity value, such that a sum of entity values of the one or more entities does not exceed the maximum entity value. Each entity value for a given entity may be variable and based on i) a concentration of the given entity being used in a current entry, a previous entry, or both, for the user or one or more other participants, ii) past statistical data temporally prior to the current entry, or iii) both. In some embodiments, the one or more processors adjusts the entity value based on a threshold of concentration being detected. According to some embodiments, an adjustment of the entity value is performed automatically.

Each of the one or more modifiers may be associated with a modifier value, and wherein the entry is limited to a maximum modifier value, such that a sum of modifier values of the one or more modifiers does not exceed the maximum modifier value. In some embodiments, each modifier value for a given modifier is variable and based on i) a concentration of the given modifier being used in a current entry, a previous entry, or both, for the user or one or more other participants, ii) historical and/or predictive data relating to the one or more factors, or iii) both. According to some embodiments, the one or more processors adjusts the modifier value based on a threshold of concentration being detected.

The one or more attributes may include a statistical record relating to an action by an entity of the one or more entities. In some embodiments, the entity corresponds to a sports player. According to some embodiments, the entity corresponds to a professional football player as part of a national football league.

The one or more attributes may be selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

In some embodiments, a plurality of modifiers of the one or more modifiers is configured to modify a single attribute score, such that the modification by the plurality of modifiers is compounded. According to some embodiments, at least some of the one or more factors include the retrieved statistical data.

At least some of the one or more factors may be external factors independent of statistical data retrieved. In some embodiments, the external factors are selected from the group consisting of weather, a stadium attendance, entity inactivity, entity injury, home field advantage, away games, and combinations thereof.

According to some embodiments, the operations further include ranking the user score for a plurality of users according to value, wherein the ranking is continually updated based on the real-time data retrieved for each user. The weighted distribution may be based on an algorithm applying pre-determined weights to each attribute score associated with the entry.

Also included in the present disclosure is a system for determining a user score, including a processor. In some embodiments, the system includes a memory storing instructions that, when executed by the processor, cause the system to perform operations. According to some embodiments, the operations include generating an entry for a user. The entry may include an entity, the entity associated with an attribute that is correlated with an attribute score. In some embodiments, the entry includes a modifier configured to modify the attribute score for the attribute. According to some embodiments, the operations include retrieving real-time data associated with the attribute for the entity, the real-time data including statistical data relating to the attribute. The operations may include determining and updating the user score in real-time. In some embodiments, determining and updating the user score in real-time is based on computing the attribute score for the attribute using the statistical data and a weighted distribution thereby forming a computed attribute score. According to some embodiments, determining and updating the user score in real-time is based on applying the modifier to modify the computed attribute score for the attribute to generate a modified attribute score. Determining and updating the user score in real-time may be based on aggregating the modified attribute score and an additional unmodified attribute score associated with the entry to generate the user score.

In some embodiments, retrieving real-time data is associated with the attribute for the entity, and the real-time data further includes a factor relating to the modifier. According to some embodiments, a modification by the modifier is based on the factor. The factor may include the retrieved statistical data. In some embodiments, the factor is an external factor independent of statistical data retrieved. According to some embodiments, the external factor is selected from the group consisting of weather, a stadium attendance, entity inactivity, entity injury, home field advantage, away games, and combinations thereof.

The entry may be generated based on a user selection of the entity, the modifier, or both. In some embodiments, at least part of the entry is generated automatically based on a prediction by the processor for maximizing the user score.

According to some embodiments, the entity is associated with an entity value. The entry may be limited to a maximum entity value, such that a sum of entity values of a plurality of entity values associated with the entry does not exceed the maximum entity value. In some embodiments, the entity value for the entity is variable and based on i) a concentration of the entity being used in a current entry, a previous entry, or both, for the user or another participant, ii) past statistical data temporally prior to the current entry, or iii) both. According to some embodiments, the processor adjusts the entity value based on a threshold of concentration being detected. An adjustment of the entity value may be performed automatically.

In some embodiments, the modifier is associated with a modifier value. According to some embodiments, the entry is limited to a maximum modifier value, such that a sum of modifier values of a plurality of modifiers associated with the entry does not exceed the maximum modifier value. Each modifier value for a modifier may be variable and based on i) a concentration of the modifier being used in a current entry, a previous entry, or both, for the user or another participant, ii) historical and/or predictive data relating to the one or more factors, or iii) both. In some embodiments, the processor adjusts the modifier value based on a threshold of concentration being detected.

According to some embodiments, the attribute includes a statistical record relating to an action by the entity. The entity may correspond to a sports player. In some embodiments, the entity corresponds to a professional football player as part of a national football league.

According to some embodiments, the attribute is selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

The modifier may be one of a plurality of modifiers configured to modify a single attribute score, such that a modification by the plurality of modifiers is compounded. In some embodiments, the user is one of a plurality of users. According to some embodiments, the operations further include ranking the user score for the plurality of users according to value. The ranking may be continually updated based on the retrieved real-time data for each user.

In some embodiments, the weighted distribution is based on an algorithm applying pre-determined weights to each attribute score of a plurality of attribute scores associated with the entry.

Also included in the present disclosure is a non-transitory, computer-readable media, executable by a processor, and configured to cause the processor to perform the step of generating an entry for a user. In some embodiments, the entry includes one or more entities, each entity associated with one or more attributes that are each correlated with a corresponding attribute score. According to some embodiments, the entry includes one or more modifiers configured to modify a respective attribute score for at least one of the one or more attributes. The non-transitory, computer-readable media may be configured to cause the processor to perform the step of retrieving real-time data associated with the one or more attributes for the one or more entities. In some embodiments, the real-time data includes statistical data relating to at least some of the one or more attributes. According to some embodiments, the real-time data includes one or more factors relating to at least some of the one or more modifiers. The non-transitory computer-readable media may be configured to cause the processor to perform the step of determining and updating the user score in real-time. In some embodiments, determining and updating the user score in real-time is based on computing the attribute score for each of the one or more attributes using the statistical data and a weighted distribution thereby forming a computed attribute score. According to some embodiments, determining and updating the user score in real-time is based on applying the one or more modifiers to modify the computed attribute score for the at least one of the one or more attributes to generate one or more modified attribute scores. A modification by the at least some of the one or more modifiers may be based on the one or more factors. Determining and updating the user score in real-time may be based on aggregating the one or more modified attribute scores and any unmodified attribute scores to generate the user score.

In some embodiments, the entry is generated based on a user selection of the one or more entities, one or more modifiers, or both. According to some embodiments, at least part of the entry is generated automatically based on a prediction by the one or more processors for maximizing the user score.

Each of the one or more entities may be associated with an entity value. In some embodiments, the entry is limited to a maximum entity value, such that a sum of entity values of the one or more entities does not exceed the maximum entity value.

According to some embodiments, each entity value for a given entity is variable and based on i) a concentration of the given entity being used in a current entry, a previous entry, or both, for the user or one or more other participants, ii) past statistical data temporally prior to the current entry, or iii) both. The non-transitory computer-readable media may be configured to further cause the processor to perform the step of adjusting the entity value based on a threshold of concentration being detected. In some embodiments, an adjustment of the entity value is performed automatically.

According to some embodiments, each of the one or more modifiers is associated with a modifier value. The entry may be limited to a maximum modifier value, such that a sum of modifier values of the one or more modifiers does not exceed the maximum modifier value.

In some embodiments, each modifier value for a given modifier is variable and based on i) a concentration of the given modifier being used in a current entry, a previous entry, or both, for the user or one or more other participants, ii) historical and/or predictive data relating to the one or more factors, or iii) both. According to some embodiments, the non-transitory, computer-readable media is configured to further cause the processor to perform the step of adjusting the modifier value based on a threshold of concentration being detected.

The one or more attributes may include a statistical record relating to an action by an entity of the one or more entities. In some embodiments, the entity corresponds to a sports player. According to some embodiments, the entity corresponds to a professional football player as part of a national football league.

The one or more attributes may be selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

In some embodiments, a plurality of modifiers of the one or more modifiers is configured to modify a single attribute score, such that the modification by the plurality of modifiers is compounded. According to some embodiments, at least some of the one or more factors include the retrieved statistical data. At least some of the one or more factors may be external factors independent of statistical data retrieved.

In some embodiments, the external factors are selected from the group consisting of weather, a stadium attendance, entity inactivity, entity injury, home field advantage, away games, and combinations thereof. According to some embodiments, the non-transitory, computer-readable media is configured to further cause the processor to perform the step of ranking the user score for a plurality of users according to value. The ranking may be continually updated based on the real-time data retrieved for each user. In some embodiments, the weighted distribution is based on an algorithm applying pre-determined weights to each attribute score associated with the entry.

Also included in the present disclosure is a non-transitory, computer-readable media, executable by a processor, and configured to cause the processor to perform the step of generating an entry for a user. In some embodiments, the entry includes an entity, the entity associated with an attribute that is correlated with an attribute score. According to some embodiments, the entry includes a modifier configured to modify the attribute score for the attribute. The non-transitory, computer-readable media may be configured to cause the processor to perform the step of retrieving real-time data associated with the attribute for the entity, the real-time data including statistical data relating to the attribute. In some embodiments, the non-transitory, computer-readable media is configured to cause the processor to perform the step of determining and updating the user score in real-time. According to some embodiments, determining and updating the user score in real-time is based on computing the attribute score for the attribute using the statistical data and a weighted distribution thereby forming a computed attribute score. In some embodiments, determining and updating the user score in real-time is based on applying the modifier to modify the computed attribute score for the attribute to generate a modified attribute score. Determining and updating the user score in real-time may be based on aggregating the modified attribute score and an additional unmodified attribute score associated with the entry to generate the user score.

In some embodiments, retrieving real-time data is associated with the attribute for the entity, and the real-time data further includes a factor relating to the modifier. According to some embodiments, a modification by the modifier is based on the factor. The factor may include the retrieved statistical data. In some embodiments, the factor is an external factor independent of statistical data retrieved.

According to some embodiments, the external factor is selected from the group consisting of weather, a stadium attendance, entity inactivity, entity injury, home field advantage, away games, and combinations thereof. The entry may be generated based on a user selection of the entity, the modifier, or both. In some embodiments, at least part of the entry is generated automatically based on a prediction by the processor for maximizing the user score.

According to some embodiments, the entity is associated with an entity value. The entry may be limited to a maximum entity value, such that a sum of entity values of a plurality of entity values associated with the entry does not exceed the maximum entity value.

In some embodiments, the entity value for the entity is variable and based on i) a concentration of the entity being used in a current entry, a previous entry, or both, for the user or another participant, ii) past statistical data temporally prior to the current entry, or iii) both. According to some embodiments, the non-transitory, computer-readable media is configured to further cause the processor to perform the step of adjusting the entity value based on a threshold of concentration being detected. An adjustment of the entity value may be performed automatically.

In some embodiments, the modifier is associated with a modifier value. According to some embodiments, the entry is limited to a maximum modifier value, such that a sum of modifier values of a plurality of modifiers associated with the entry does not exceed the maximum modifier value.

Each modifier value for a modifier may be variable and based on i) a concentration of the modifier being used in a current entry, a previous entry, or both, for the user or another participant, ii) historical and/or predictive data relating to the one or more factors, or iii) both. In some embodiments, the non-transitory, computer-readable media is configured to further cause the processor to perform the step of adjusting the modifier value based on a threshold of concentration being detected.

According to some embodiments, the attribute includes a statistical record relating to an action by the entity. The entity may correspond to a sports player. In some embodiments, the entity corresponds to a professional football player as part of a national football league.

According to some embodiments, the attribute is selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

The modifier may be one of a plurality of modifiers configured to modify a single attribute score, such that a modification by the plurality of modifiers is compounded. In some embodiments, the user is one of a plurality of users. According to some embodiments, the non-transitory, computer-readable media is further configured to cause the processor to perform the step of ranking the user score for the plurality of users according to value. The ranking may be continually updated based on the retrieved real-time data for each user. The weighted distribution may be based on an algorithm applying pre-determined weights to each attribute score of a plurality of attribute scores associated with the entry.

Also included in the present disclosure is a method, including generating an entry for a user. In some embodiments, the entry includes an entity associated with an attribute, the attribute correlated with an attribute score. According to some embodiments, the entry includes a modifier configured to modify the attribute score. The method may include retrieving real-time data associated with the attribute, the real-time data including statistical data relating to the attribute. In some embodiments, the method includes modifying the attribute score based on the modifier. According to some embodiments, the method includes determining a user score based at least partly on a weighted distribution of a plurality of modified attribute scores. The method may include updating the user score in real-time based on the real-time data.

In some embodiments, updating the user score includes computing the attribute score for the attribute using the statistical data and the weighted distribution. According to some embodiments, updating the user score further includes aggregating the modified attribute score and any unmodified attribute scores to generate the user score.

The real-time data may further include a factor relating to the modifier. In some embodiments, updating the user score includes computing the attribute score for the attribute using the statistical data and the weighted distribution. According to some embodiments, modifying the attribute score further includes applying the modifier to modify the computed attribute score for the attribute to generate a modified attribute score. A modification by the modifier may be based on the factor. Updating the user score may further include aggregating the modified attribute score and any unmodified attribute scores to generate the user score.

In some embodiments, generating the entry for the user includes the user selecting the entity, the modifier, or both. According to some embodiments, generating the entry for the user includes automatically generating the entry based on a prediction by a processor for maximizing the user score. The method may further include associating the entity with an entity value.

In some embodiments, the method further includes limiting the entry to a maximum entity value, such that a sum of entity values of multiple selected entities associated with the entry does not exceed the maximum entity value. According to some embodiments, the method further includes varying the entity value for the entity based on a concentration of the entity being used in a current entry, a previous entry, or both, for the user or another participant. The method may further include varying the entity value for the entity based on past statistical data. In some embodiments, the method further includes varying the entity value for the entity based on a concentration of the entity being used in a current entry, a previous entry, or both, for the user or another participant and past statistical data.

According to some embodiments, the method further includes adjusting the entity value based on a threshold of concentration being detected. The method may further include automatically performing the adjustment of the entity value.

In some embodiments, the method further includes associating the modifier with a modifier value. According to some embodiments, the method further includes limiting the entry to a maximum modifier value, such that a sum of modifier values of multiple selected modifiers associated with the entry does not exceed the maximum modifier value. The method may further include varying the modifier value for the modifier based on a concentration of the modifier being used in a current entry, a previous entry, or both, for the user or another participant. In some embodiments, the method further includes adjusting the modifier value based on a threshold of concentration being detected. According to some embodiments, the method further includes automatically performing the adjustment of the modifier value.

The method may further include associating the modifier with a modifier value. In some embodiments, the method further includes limiting the entry to a maximum modifier value, such that a sum of modifier values of multiple selected modifiers associated with the entry does not exceed the maximum modifier value. According to some embodiments, the method further includes varying the modifier value for a given modifier based on historical and/or predictive data relating to the factor. The method may further include varying the modifier value for a given modifier based on a concentration of the given modifier being used in a current entry, a previous entry, or both, for the user or another participant and historical and/or predictive data relating to the factor.

In some embodiments, the method further includes adjusting the modifier value based on a threshold of concentration being detected. According to some embodiments, the method further includes automatically performing the adjustment of the modifier value. The modifier may be one of a plurality of modifiers. In some embodiments, the method further includes modifying a single attribute score, such that a modification by the plurality of modifiers is compounded.

According to some embodiments, the method further includes including the retrieved statistical data in the factor. The method may further include ranking the user score for a plurality of users according to value. In some embodiments, the method further includes continually updating the ranking based on the retrieved real-time data for each user of the plurality of users. According to some embodiments, the method further includes applying a pre-determined weight to each attribute score of a plurality of attribute scores associated with the entry.

Also included in the present disclosure is a method, including generating an entry for a user. In some embodiments, the entry includes one or more entities, each entity associated with one or more attributes that are each correlated with a corresponding attribute score. According to some embodiments, the entry includes one or more modifiers configured to modify a respective attribute score for at least one of the one or more attributes. The method may include retrieving real-time data associated with the one or more attributes for the one or more entities. In some embodiments, the real-time data includes statistical data relating to at least some of the one or more attributes. According to some embodiments, the real-time data includes one or more factors relating to at least some of the one or more modifiers. The method may include determining the user score in real-time. In some embodiments, determining the user score in real-time is based on computing the attribute score for each of the one or more attributes using the statistical data and a weighted distribution thereby forming a computed attribute score. According to some embodiments, determining the user score in real-time is based on applying the one or more modifiers to modify the computed attribute score for the at least one of the one or more attributes to generate one or more modified attribute scores, wherein a modification by the at least some of the one or more modifiers is based on the one or more factors. Determining the user score in real-time may be based on aggregating the one or more modified attribute scores and any unmodified attribute scores to generate the user score.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The foregoing may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A system for determining a user score, the system comprising:
one or more processors; and
one or more memories storing instructions that, when executed by the one or more processors, cause the system to perform operations including;
generate an entry for a user, the entry comprising:
one or more entities, each entity associated with one or more attributes that are each correlated with a corresponding attribute score; and
one or more modifiers configured to modify a respective attribute score for at least one of the one or more attributes;
retrieve real-time data associated with the one or more attributes for the one or more entities, the real-time data comprising:
statistical data relating to at least some of the one or more attributes; and
one or more factors relating to at least some of the one or more modifiers; and
determine the user score in real-time based on:
computing the attribute score for each of the one or more attributes using the statistical data and a weighted distribution thereby forming a computed attribute score;
applying the one or more modifiers to modify the computed attribute score for the at least one of the one or more attributes to generate one or more modified attribute scores, wherein a modification by the at least some of the one or more modifiers is based on the one or more factors; and
aggregating the one or more modified attribute scores and any unmodified attribute scores to generate the user score.

2. The system of claim 1, wherein the entry is generated based on a user selection of the one or more entities, one or more modifiers, or both.

3. The system of claim 1, wherein at least part of the entry is generated automatically based on a prediction by the one or more processors for maximizing the user score.

4. The system of claim 1, wherein each of the one or more entities is associated with an entity value, and wherein the entry is limited to a maximum entity value, such that a sum of entity values of the one or more entities does not exceed the maximum entity value.

5. The system of claim 4, wherein each entity value for a given entity is variable and based on i) a concentration of the given entity being used in a current entry, a previous entry, or both, for the user or one or more other participants, ii) past statistical data temporally prior to the current entry, or iii) both.

6. The system of claim 5, wherein the one or more processors adjusts the entity value based on a threshold of concentration being detected.

7. The system of claim 6, wherein an adjustment of the entity value is performed automatically.

8. The system of claim 1, wherein each of the one or more modifiers is associated with a modifier value, and wherein the entry is limited to a maximum modifier value, such that a sum of modifier values of the one or more modifiers does not exceed the maximum modifier value.

9. The system of claim 8, wherein each modifier value for a given modifier is variable and based on i) a concentration of the given modifier being used in a current entry, a previous entry, or both, for the user or one or more other participants, ii) historical and/or predictive data relating to the one or more factors, or iii) both.

10. The system of claim 9, wherein the one or more processors adjusts the modifier value based on a threshold of concentration being detected.

11. The system of claim 1, wherein the one or more attributes comprises a statistical record relating to an action by an entity of the one or more entities.

12. The system of claim 11, wherein the entity corresponds to a sports player.

13. The system of claim 12, wherein the entity corresponds to a professional football player as part of a national football league.

14. The system of claim 13, wherein the one or more attributes is selected from the group consisting of touchdowns scored, touchdown passes, touchdown rushes, passing yards, rushing yards, rushing attempts, tackles, sacks, field-goals made, field-goals missed, field-goals made further than a predetermined distance, fumbles, fumble recoveries, incomplete passes, completed passes, interceptions, receptions, turnovers, offensive score, defensive score, overall score, offensive snaps, punt return yards, kick return yards, receiving targets, single run yardage, single pass yardage, and combinations thereof.

15. The system of claim 1, wherein a plurality of modifiers of the one or more modifiers is configured to modify a single attribute score, such that the modification by the plurality of modifiers is compounded.

16. The system of claim 1, wherein at least some of the one or more factors include the retrieved statistical data.

17. The system of claim 1, wherein at least some of the one or more factors are external factors independent of the statistical data.

18. The system of claim 17, wherein the external factors are selected from the group consisting of weather, a stadium attendance, entity inactivity, entity injury, home field advantage, away games, and combinations thereof.

19. The system of claim 1, wherein the operations further include ranking the user score for a plurality of users according to value, wherein the ranking is continually updated based on the real-time data retrieved for each user.

20. The system of claim 1, wherein the weighted distribution is based on an algorithm applying pre-determined weights to each attribute score associated with the entry.

21.-117. (canceled)
